(19) United States
(12) Patent Application Publication
(10) Pub. No.: US 2017/0206562 A1
(43) Pub. Date: Jul. 20, 2017

(54) DISPLAY NETWORK SYSTEM AND METHOD

(71) Applicant: Craig P. Mowry, Southampton, NY (US)

(72) Inventor: Craig P. Mowry, Southampton, NY (US)

(21) Appl. No.: 15/420,883

(22) Filed: Jan. 31, 2017

Related U.S. Application Data
(63) Continuation of application No. 12/900,204, filed on Oct. 7, 2010, now abandoned.
Application No. 12/900,204 is a continuation of application No. 12/691,688, filed on Jan. 21, 2010, now abandoned.
Application No. 12/691,688 is a continuation-in-part of application No. 11/517,114, filed on Sep. 6, 2006, now abandoned.
(60) Provisional application No. 61/249,576, filed on Oct. 7, 2009.
(60) Provisional application No. 61/205,469, filed on Jan. 21, 2009.
(60) Provisional application No. 61/205,444, filed on Jan. 21, 2009.
(60) Provisional application No. 61/205,914, filed on Jan. 26, 2009.
(60) Provisional application No. 61/208,037, filed on Feb. 20, 2009.
(60) Provisional application No. 60/714,275, filed on Sep. 6, 2005.
(60) Provisional application No. 60/739,354, filed on Nov. 22, 2005.

(51) Int. Cl. G06Q 30/02

(52) U.S. Cl. CPC G06Q 30/0269; G06Q 30/0255

(57) ABSTRACT

A system and method that includes at least one database storing electronic user information representing at least traits and/or preferences of a plurality of respective persons, and user identification information representing contact information for at least one person of the plurality of persons. The database further stores advertiser information relating to one or more of products and services associated with one or more advertising entities. First electronic user information is received that includes identification information representing a first user, and product alteration information is received that represents at least a physical alteration of at least one of the one or more products. At least one advertiser computing device is selected for receiving electronic user information, and the electronic user information is transmitted thereto.

### RELATED APPLICATIONS

The present application is a continuation of prior U.S. patent application Ser. No. 12/691,688, filed Jan. 21, 2010, which claims priority to U.S. Provisional Patent Application Ser. Nos. 61/205,469, filed Jan. 21, 2009, 61/205,444, filed Jan. 21, 2009, 61/205,914, filed Jan. 26, 2009, and 61/208,037, filed Feb. 20, 2009, and which is a continuation-in-part of U.S. patent application Ser. No. 11/517,114, filed Sep. 6, 2006, which claims priority to U.S. Provisional Patent Application Ser. Nos. 60/714,275, filed Sep. 6, 2005 and 60/739,354, filed Nov. 22, 2005, further, the present application claims priority to U.S. Provisional Patent Application No. 61/249,576, filed Oct. 7, 2009, the entire contents of all of which are hereby incorporated by reference.

### BACKGROUND

Field of the Invention

The present invention relates generally to advertising and, more particularly, to providing a networked public display system.

Description of the Related Art

Advertising that is provided in spaces that are visible to the public, such as billboards, lighted phone kiosks and projected image surfaces, are known. Although prior art advertisement in these and related spaces is useful for disseminating messages to large numbers of people, limitations exist that hinder their effectiveness. For example, targeting options for advertisers, including options relating to a type of media that are capable displaying content, as well as timeframe for display and location specificity of displayed content, limit the ability of advertisers to target a desired cross-section or specific viewers. As used herein, the term “viewer” refers, generally, to a person who views a display screen, including a public display screen. Moreover, prior art public displays lack an operability that would otherwise increase a commercial, entertainment and informational value.

A variety of systems and methods for exchanging data between wireless devices are known. One example is the PDA to PDA exchange of data between two cell phones that embody operability to purposefully exchange identification data with other compatible cell phones, or related wireless devices.

The marketing importance of providers of goods and services being able to track and/or incentivize consumers, or potential customers, cannot be overstated in the competitive commercial environment of today. For example, stores may offer trackable customer incentive accounts, such as added value cards or discount certificates or cards, in order to track such customer purchases relative to their identities. Such identity information is often collected when providing or registering for such incentive accounts

Printed magazines sold at newsstands are a good example of products that typically forego collecting information about those who purchase, as cash is often exchanged for single issue copies at point of purchase locations. Such printed magazines derive a portion of their income from advertising sales, which is based on subscription numbers presented by the publishers to potential advertisers. Without customer name and address information, publishers cannot be claimed within these important subscription totals, on which at least advertising fees for a given publication are at least in part based. Perhaps the single most important demographic to such a publication, sold at a newsstand, would be those individuals willing to pay full cover price for single copies, this purchase demonstrates perhaps the highest degree of consumer interest in the subject matter of a branded publication.

Accordingly, an interactivity between viewers of advertisement displays is desirable to provide enhanced advertising, data sampling and cross network viewing and interaction between viewers and providers of content.

### SUMMARY

In an embodiment, a system and method that includes at least one database storing electronic user information representing at least traits and/or preferences of a plurality of respective persons, and user identification information representing contact information for at least one person of the plurality of persons. The database further stores advertiser information relating to one or more of products and services associated with one or more advertising entities. First electronic user information is received that includes identification information representing a first user, and product alteration information is received that represents at least a physical alteration of at least one of the one or more products. At least one advertiser computing device is selected for receiving electronic user information, and the electronic user information is transmitted thereto.

Moreover and in an embodiment, the electronic advertiser information relates to one or more promotions. The promotion(s) may be an offer for a free product or service, and/or may be an account credit. Moreover, the promotion may relate to media that features the first user.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings several forms which are presently preferred, it being understood, however, that the invention is not limited to the precise arrangements and instrumentalities shown. The features and advantages of the present invention will become apparent from the following description of the invention that refers to the accompanying drawings, in which:

FIG. 1 is a diagram illustrating an example information managing system that receives and conveys a variety of information types between a plurality of system components in accordance with an embodiment;

FIG. 2 illustrates the functional elements of an example information processor and/or workstation in accordance with an embodiment;

FIG. 3 shows targeted viewers that are profiled in relation to electronic transmissions and a corresponding display, in accordance with an embodiment;

FIG. 4 is a diagram illustrating an example including operability pertaining to one or more display(s) in a moving vehicle;

FIG. 5 shows interactive operability relating to profiling targeted viewers and focusing and content display options in accordance with an embodiment; and

FIG. 6 illustrates an example wherein a customer utilizes product and packaging at a point-of purchase in accordance with an embodiment.

### DESCRIPTION OF EMBODIMENTS

A system and method in accordance with the present application provide versatility for public advertising, such as via public displays, which may be monitors, screens or the like. In a preferred embodiment, electronic files or other data are distributed via an Internet or other interactive communication network, and are sent from a user computing device to a system hub that includes at least one information processor, such as a server computing device. The electronic files or other data source contain information and/or content that may be displayed or otherwise provided on one or more selected networked displays, based on at least one parameter, including one or more locations of the display(s), whether the display(s) are fixed or movable, as well as a particular time-frame for providing the information and/or content, and one or more targeted viewers of the content. Moreover, one or more discreet network programming priorities that are distinct from content provider and/or user-based priorities may also determine when and where content is to be provided. In one context, visually displayable content may be provided as video or other electronic visuals and may be provided by direct view and/or projector device-related components. Other suitable image or content media are envisioned, such as set forth herein.

Further, interactivity between respective viewers of a plurality of displays, which may include the exchange of information and data, enables the teachings herein to emulate or operate as a social network that includes public displays. This facilitates improved data gathering, advertising versatility and direct selling operability, as well as enhances the ability to target viewers through an interactive exchange of data between viewers and/or display(s). Further, an interactive, public display social network in accordance with the teachings herein provides collaboratively created content as a function of at least viewer interactivity exchanges that provide for a secondary use of network-generated and/or displayed content. For example, network-generated and/or affected content is provided via Internet channel(s) and/or television programming, or other continual and/or episodic programming, which may be provided in a live or prerecorded format.

Accordingly, a network of electronic displays is provided that allows users to submit content via an interactive network, such as the Internet, for inclusion on the one or more displays of the network. These submissions may be displayed according to a variety of parameters that are valued by the user and/or one or more providers information processors on the network, such as cost, display location(s), desired time frame for display, as well as trait, preference and/or other parameters utilized by system computing for targeting viewers of networked displays.

In an embodiment, a visual display network including monitors placed in public places, is operable for each of the monitors to be individually programmed to provide content that is related to a plurality of sources, including home computing devices. Examples of such programmable monitors are disclosed in U.S. patent application Ser. No. 09/756,278, entitled ELECTRONIC, PUBLIC ADDRESSING VISUAL DISPLAY NETWORK, and filed Jan. 9, 2001, which is incorporated by reference, herein.

The visual display network in accordance with preferred embodiments improves and expands upon prior art visual displays and allows for additional specific programming aspects, including programming based on the public's, or one or more viewers', participation. In one configuration, an electronic and/or other form of sampling of viewers in a particular geographical area is provided for potential selection, customization and/or alteration of content that is presented on one or more displays. In this example configuration, one or more hub computers is operatively configured to access one or more database to receive, collate and/or transmit data that relate to an advertiser or other paying party's electronic and/or other paid content submissions and target audience parameters. The one or more hub computers may determine whether to approve and provide such submissions, as well as the place, time and particular form and frequency that such paid content is to be featured on one or more displays of the network. In one embodiment and pursuant to an agreement with an advertiser or other paying party's and a corresponding confirmation for providing the content in accordance with one or more parameters, the content is displayed. The parameters may be defined or at least influenced by predetermined conditions provided with the one or more hub computers.

Selectively, with or without the consent of individuals, at least one module of the network may receive and process, or relay for processing, electronic transmissions from or relating to people within a determined proximity of one or more displays of the network. Further, criteria and/or information related to potential advertising targets (e.g., viewers of networked display monitors) may be collected and factored by modules or components provided on the network that include but are not limited to physical characteristics of individuals who are targeted for network selected content. Moreover, transmission from an interactive or other signal generating identification device may be provided “locally” or via an external database and may include at least data or other aspect related to the advertising target/viewer(s) and may also affect automatic network determination(s) vis-à-vis displayed or presented media.

In yet another configuration, customized content creation and/or content selection may include tailoring audio, visual or other sensory stimuli based on information that is gathered and that relates to at least one individual viewer who is targeted to be exposed to content presented on at least one monitor of the network. Further, opportunities may be provided that relate to the at least one viewer's participation. Alternatively or in addition, the at least one viewer may provide permission for access to information related to an individual viewer may allow advertisers to access personal data and other information available on external databases, or transmitted directly from an individual electronically, toward media targeted toward that individual(s) at least in part based on such information.

Within a preferred network/venue configuration, an identified advertisement targeted viewer may function as at least a stimulus for data to be modified within content supplied to at least one networked monitor, for further targeting of that viewer. For example, the content may be modified to incorporate the name of the viewer (i.e., the advertisement target) visually within one or more visual displays, when the viewer is within sight of the visual display. Moreover, audio and/or visual content may be also altered to target the viewer, such as to include the viewer's likeness or certain information related to the viewer within the one or more visual displays. Moreover, the viewer's name may be featured audibly to accompany one or more visual displays. Information may be retrieved from one or more databases that may be external to the one or more hub computers and a special incentive or opportunity for which the advertisement targeted viewer might be presented. For example, the visual display may provide the following language, “Joe Blow! As an AMERICAN EXPRESS cardholder you are entitled to a 50% discount today only at BANANA REPUBLIC, which is straight ahead the direction you are walking!”

In an embodiment, a viewer who has previously provided authorization or provides authorization in response to one or more networked-provided prompts, may trigger a modification to content that is planned to be provided on at least one display of the network. The trigger may occur when the individual's cellular telephone signal is identified by a communications module of the network. In this embodiment, when information related to the viewer is accessed and that is based on at least some information transmitted by the viewer's cellular telephone or other signal, one or more networked computing devices may factor an aspect of personal information related to the viewer. For example the viewer drives a MERCEDES automobile, and an advertisement for luggage which is designed specifically to fit in trunks of MERCEDES automobiles appears on the phone kiosk as the viewer passes by.

Further and to demonstrate the multi-directional individual addressability of the network, the following example is provided. A female viewer uploads content over the network under a paid or other agreed upon arrangement. The female viewer indicates one or more parameters, such as a location for her preferred content to selectively appear, and when a male fitting her target demographic criteria is within proximity of a monitor within her selected area, her previously agreed-upon visual and contact information is displayed or otherwise provided on the monitor. In essence, the solicitation (provided under prescribed parameters, such as timeframe, location and target audience criteria) may appear specifically to reach one or more individuals. Thus, the visual display network also provides for targeted advertising and communication, from as few as one individual to as few as one other individual.

The above example demonstrates the expansion of the present application over prior art social networking venues, including a new “person to person” targetable outdoor display system and method. Further, other electronic connecting features allow for interactive exchanges of information. For example, a female has uploaded or otherwise provided her own image to one or more hub computers, and is detected by one or more public display devices asking a male if she might send him her contact information electronically to a personal digital assistant (“PDA”), such as a cellular telephone. The PDA might have provided certain information related to the male advertisement target/viewer. This example demonstrates the potential exchange of information between one or more advertisement providers and viewers, such that a display system in accordance with the teachings herein provides for.

Targeting individuals who are in the proximity of a networked display monitor further impacts the selection and/or preparation of content to be provided on at least one monitor within as little as a few seconds or less. In conjunction with or distinct from electronically transmitted target individual identification information, component(s) of the network thus identifies at least a likelihood of gender, height, apparel, ethnicity and/or other aspects useful in personal profiling for ever greater targeted options by and for the network.

Even fragrance, in an embodiment, may be a factor sampled relative to viewers within a selected proximity to a network monitor. This embodiment includes a sensory stimulus capable of being electronically sampled by aspects/components of the network, toward affecting content provided on a display, including based on trait or preference data derived from such a sampling. Expensive fragrance, for example, might dictate an advertisement to appear as a female who is wearing the fragrance walks by a display, and the advertisement solicits her to purchase jewelry from a luxury store, which may be in the vicinity of the female and the display.

Moreover, additional networked display specific content selection and/or modification is provided herein that may include data related to a location or position of a display monitor. For example a mobile monitor, such as one featured in a taxi cab, may provide content at least in part based on the location of the taxicab at any given point in time. When the taxi enters the upper east side of New York City, content may be featured on the monitor that is relevant thereto. In one embodiment, the content may be based upon global positioning system (“GPS”) information, such as a particular zone where the taxi has entered.

Accordingly, the dynamic location or position of one or more monitor(s) or display aspect(s) of such a network may impact media featured on such monitor(s) as a function of selected and/or preprogrammed instructions stored within at least one database. Such positional data, such as GPS data, might come from other network linked, or accessed devices, such as a cellular telephone tower transmissions or specially placed network devices that operate via system components to identify position information related to network display(s) or the like.

The teachings herein provide for enhanced audience targeting and operability for as few as one viewer, for example, to target single viewers for receiving content provided by way of an Internet site to the network. For example, an actor provides an image of himself (e.g., the actor's “headshot”) and his name to be displayed near a bus stop in the vicinity of the Los Angeles talent agencies, for a single week to appear during hours when agents are expected to be arriving and leaving their agencies. This actor's content is effectively an advertisement. Further, updates to the actor's image, information and the frequency with which his advertisement appears on this one bus stop display, may be paid for, controlled, or updated, from his mobile device, such as a cellular telephone or “smart phone,” e.g., a BLACKBERRY or IPHONE. Continuing with this example and based on other proprietary transactional options in accordance with the teachings herein, the actor provides his head shot or other content for display to agents, and is charged therefor based on how many people are identified electronically and/or interact with the network in response to the actor's provided content.

Other, more specific fee-based structures are provided herein, that enable clients to apply and provide for new levels of advertising targeting and specificity not available in the prior art. For example, fees charged to users of the system, or content providers, are charged to clients based on a number of selectively verified or “ranked” individuals meeting predefined demographic criteria pass by and/or are electronically identified for meeting the criteria and/or who interact with the media.

For example, a talent agent who sees the actor's head shot or other content, might be agreeably identified as a “CAA” agent by his cell phone ID as determined by the network via one or more external databases. As that agent, John James, passes a display featuring the actor's image, a visual or audio prompt occurs and that is generated and/or presented by the system. Continuing with this example, the display monitor/provides a message: “MR. JAMES, may I forward my contact info to your cell phone?” or “may I call you for an appointment Mr. James?” Moreover, interactive options, such as the agent replying vocally “yes, call my secretary, Susan,” might be relayed by the network to the client as a recorded or live media transmission.

Thus, targeting by area, time frame, and specificity as narrow as a specific display of the network is provided selectively to users. Users of the teachings herein are not only advertisement agencies and firms, as in the prior art, but individual home computer users or general members of the public. Anyone with an electronic device that is compatible with network accessing parameters, can submit credit card or other payment information and enjoy the benefits and features provided herein. Further, a single individual may not only provide targeted content by place, timeframe, cost parameters, or other parameters, but may also provide target images within one or more network options and configurations to display content when one or more viewers is selectively identified as within an acceptable range of a target demographic and/or within a predetermined distance of a networked display/monitor.

In addition, content provided by users may be modified based on information related to one or more viewers who are within range of network display and that satisfy parameters agreed to between the client (content provider) and proprietor of a display network. Further and in an embodiment, incentives and other information are provided to the targeted viewer(s) of display(s) of the network, based on information gathered by the network and provided by the targeted viewer(s) in the vicinity of and operating in tandem with at least one networked display.

Signals or other identification aspects related to a targeted viewer of a display may also trigger one or more hub computers to access data from other databases that are accessible to the one or more hub computers. The one or more hub computers determine which particular content, generated information and/or visual/audio or other sensory stimuli would be most successful (or most lucrative) given the targeted viewer(s).

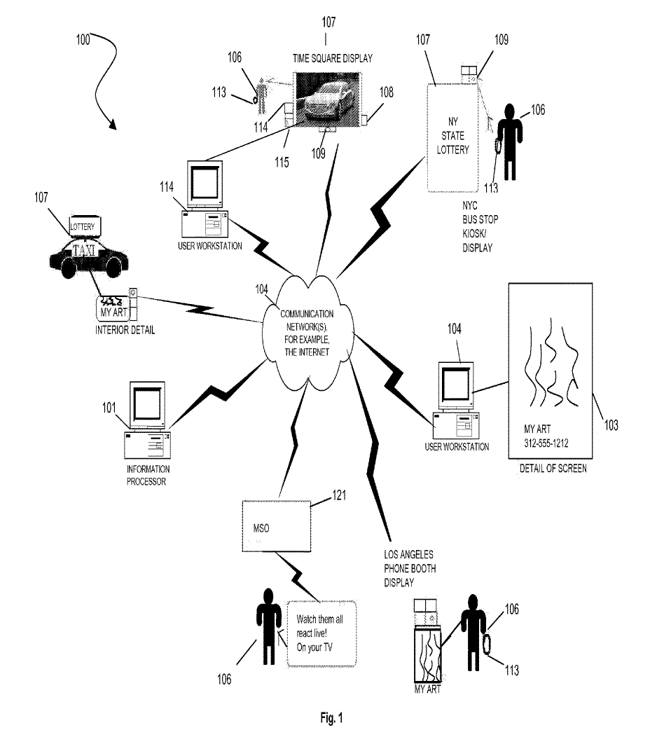

The following embodiments are described with reference to FIGS. 1 through 6, which demonstrate features and operability of the teachings herein.

Referring now to FIG. 1, information managing system 100 includes hub information processor 101 that receives and conveys a variety of information types between a plurality of system components. Primarily, hub information processor 101 receives and conveys information related to content between one or more computing devices operated by content providers. The devices display at least aspects of the provided content according to parameters, such as the target objectives of the content providers. These and other priorities may include pre-programmed network-based priorities, factoring variables such as revenue potential of selected content and/or interactive options at a given time and/or relevance of the various content/interactive options to target viewer(s) 106, of one or more displays of the system 100.

A home computer user uses a laptop or other computing device 103, to communicate via Internet or other network 104. For example, a user interested in targeting his own artwork to members of the public as featured by media including a digital visual of his work 105.

To demonstrate the improvements to conventional “out-of-home” advertising options, the user of the computing device 103 targets his provided content to potential viewers based on a plurality of distinct parameters involving different aspects of system/method viewer targeting operability. Hereafter, viewers of network display(s) 106 who may, or may not, interact with such display(s) will be referred to as targeted viewers 106.

User of computing device 103 preferably logs onto an Internet Site provided via system 100. This site provides a variety of interactive options, which may include “joining” an interactive venue, uploading content, indicating desired viewership (targeted viewers 106) parameters, payment/credit options for using the service as well as a range of other options that will be described in greater detail in relation to other Figures, herein. The user makes a variety of “placement” requests, based on different combinations of priorities to him. The following examples relate to such placement requests.

A first placement request example is for June 1 through June 5, on several individually selected displays 107 in two zip codes of Los Angeles. This user reviewed specific demographic information provided as an option and function of the system 100. This demographic information including types of viewers familiar to selected displays 107 and anticipated viewership, by type and number of targeted viewers 106 among other relevant criteria. In the present example, the user's selection of display 107 was only informed by this information, with his selection being primarily based on two parameters: the location of the displays 107 and cost to run his content.

By “capping” his available spending to $250 for this cycle, this user is given system provided parameters/options for visibility on the selected display(s) for those days using that available budget. These parameters include variables such as “hours of the day” that certain units may provide the content, any specific aspects of viewers over those specific time frames that may vary from previous demographic information provided, length of time(s) the content may be displayed at any one time, (if not a fixed timeframe piece of content such as video clip), among other relevant information including alternate options for display requests, which may or may not be available.

For his second placement request, the user has requested displays 107, including bus stop displays and phone kiosks, which are placed in the vicinity of cultural and artistic venues in three major cities: Los Angeles, San Francisco and Phoenix. Computing operability provided in specific programming, return options for the user's supplied art/content to be provided at certain times on available displays 107, two of which require shorter durations to appear. For example, 5 seconds instead of 10 per feature of the user's content as those two displays 107 have more content demands and are considered “preferred display locations” in the particular network configuration.

When hub information processor 101 or other computing device analyzes the user's own defined priorities, a system feedback targeting application is preferably triggered resulting in an option that suggests to the user to “consider adding displays near Los Angeles talent agencies and movie studios, because agents and employees in the film industry are among those most likely to spend funds on artistic endeavors, including the purchase of fine art.” Based on this information, the user agreeably allows for the addition of twelve phone kiosk displays 107 that are located near entertainment industry company headquarters, and that supplement those which occur outside of cultural venues, such as theatres and museums. Thus, additional and/or alternate opportunities are optionally provided, at the system's determination and/or special request by the user, for the user to reach desired targeted viewers 106, or targeted viewers 106 that the user has learned are perhaps equal to, or better than, his/her own previous understanding of the most likely demographic(s) for his/her content to find successful exposure.

In another placement request example, the user selects the same dates as set forth in the first request, though his criteria is more specific. For his next $250 he has selected a system targeting option called “viewer ID.” Though he has the option of including additional target narrowing criteria, such as “display locations/regions,” the user allows for any regions and selects alternate targeting operability of the system/method defining his target by traits and/or preferences.

In this example, the user selects “men over 30 with incomes over $150,000,” and directs an active or passive profile of individuals who pass by the vicinity of display(s) 105 during the periods when the user's content is displayed. For example, in an “active” profiling scenario, a potential targeted viewer 106 (which may be a cellular telephone, smart phone, PDA or the like), is identified by interactive exchange of signals, in this case between his portable device 113, and signal receiving/transmitting display component 109. In this case, the targeted user 106 is solicited to, or has in the past, provided an electronic instruction relevant to the hub information processor 101 to access information related to him. This may occur in conjunction with an incentive offered on and/or via a display 107, or may have been provided previously through portable device 113 or another device used by the targeted viewers 106. Display 107, as operated via a workstation 114, manages information received/sent to targeted viewers 106, and functions in tandem as an adjunct computing component of the system and hub information processor 101.

In a “passively” profiled target scenario, a targeted viewers 106 signals may be analyzed without the user's knowledge or permission, for example, to simply identify an AT&T cellular user is near the display 107. A more discreet range of passive sampling operabilities, in this scenario, include the imaging aspect of the display 107, digital camera and audio gathering unit 115, provide at least visual cues as to at least trait(s) of individuals in the vicinity of the display. Such visual and/or audio gathering components may be a fixed aspect of a display 107, or separately placed, collecting information about approaching, background, or other system relevant information pertaining to individuals who may be ranked according to target value, relevant to the system priority software 110, and/or the user.

Thus, a recognition operability of hub information processor 101 and/or workstation 114, may in a simple example, distinguish visually the potential targeted viewers 106 as a male over six feet tall, based on programmed visual cue data that may identify such traits within a reasonable margin of error/acceptability. Further, target relevant information gathering component 108 may include further operability to gather other “sensory related” stimuli, beyond audio/video, including olfactory stimuli. In this scenario identifying the male as wearing a fragrance, with subsequent analysis (accomplished before the targeted viewers 106, is beyond the display) revealing the brand of the fragrance gathered, in similar data profiling and comparing programming as available with musical song data of various qualities and completeness being identified against more ideal or complete data files of the audio file such gathered samples related thereto. More discreet stimuli may be analyzed by such systems and may include immediately sampled genetic material related to target(s) and even brainwave or other physiological activity revealing information about the state and/or thoughts of the target.

In this example scenario, the user of computing device 104 further selects a premium option in which the display(s) will solicit through audio and/or video content, targeted viewers 106 to provide “feedback” about art featured by this user's displayed content. This option may include system and/or user relevant incentives to targeted viewers 106, provided by the display or network operability presenting interactive information, such as incentive information, to the user's portable device 113. Such interactivity may also provide the gateway, or dialogue, leading to agreeable release and/or collection of other target relevant information, provided verbally, electronically or otherwise. Verbal recognition software operability within hub information processor 101 and/or 114, may convert and provide a target viewer's audio as data, informing an interactive dialogue with targeted viewers 106. Thus, the teachings herein provide for further data gathering and advertising to a targeted viewers 106 that is relevant to the targeted viewers 106, and/or other system relevant advertisers and/or content providers and/or content viewers.

In an expanded interactive operability, and described in greater detail with reference to other Figures, targeted viewers 106 may be included in an interactive dialogue with at least another user, Other enhanced interactivity may include content providers, and/or other display system targeted viewers 106, among other network linked participants/viewers, whether through a live exchange and/or an exchange of pre-recorded audio and/or video, such as video collected by sensory stimuli gathering component (a camera, in this example) 108. Thus, an advertising user may not only reach his desired, or learned, targeted viewers 106, but may interact and/or gather information relevant to his objectives. Even transactions may occur via system operability linking a user with target 106, whether live or by data managing system exchange operability trafficked and managed under system parameter software, by system computing components such as via hub information processor 101 and/or workstation 114. Discreet target involving operability, facilitated by specific programming features of the system 100 (which may be managed/maintained at the hub processor 101 and/or display computing workstation 114), provides an ability for captured video of the target 106, to be married with other content, to provide at least that target 106, with a displayed visual of himself inside an environment, such as a living room, with the piece of art being advertised, hanging on a wall in front of a visual(s) of that target viewer 106.

Thus, personalization of products/services promoted by the present system/method, may substantially and immediately involve actual or virtual media in revised media provided by display 107, demonstrating applications and/or personal relevance potential to a targeted viewer 106. For example, if the targeted viewer 106 provides (actively or passively) information about his “style” relative to home décor, the art visual 103, may be featured in a “modern” room, in a customized visual, (whether featuring actual imagery of the target viewer 106, gathered and/or accessed by system component(s)), increasing the potential relevance and interest in the piece to targeted viewer 106, by introducing ancillary information and/or aspects to the displayed/provided content.

Thus, relative to conventional “out-of-home” displays, whether still or motion content, the teachings herein improve at least the option(s) for more potential content providers to provide content to other individuals, as well as the immediacy with which content may be provided to virtually any location on Earth, and be made available by a variety of venues. The targeting of viewers, based on many criteria options beyond simply location, the interactive data exchange including focus group data gathering from viewers, the incentivizing and even transacting with viewers, leading to more discreet selling, promoting and data gathering are among other improvements provided by this content exchanging advertising, and social interaction, venue, system and method.

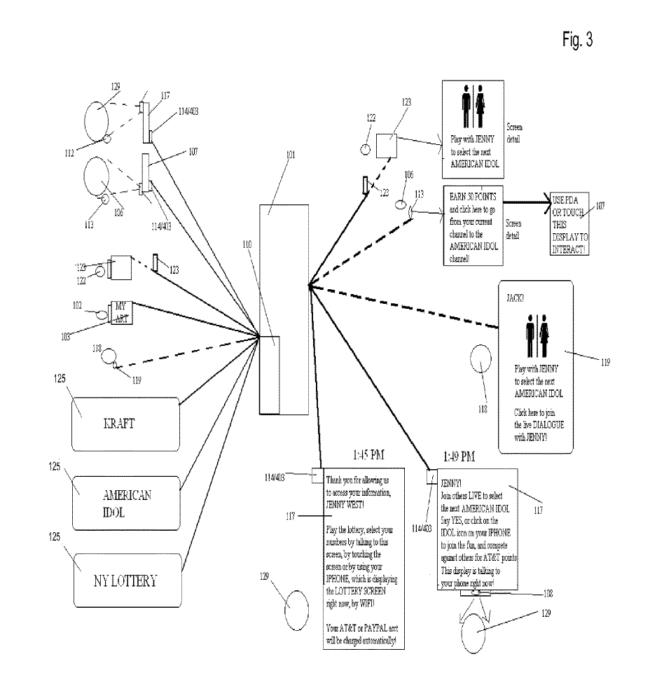

Other advertisers 125 of the various views may have broader coverage objectives reaching more target viewers 106, than a home content provider, such as user of computing device 104, or other users who have provided advertising and/or other content to the venue, such as via a BLACKBERRY to transact and upload content to hub information processor 101 (see FIG. 3). In his case, by way of a special venue software application provided on his PDA when he bought it, which may be also downloadable through the Internet for such units not “pre-loaded” with the operability.

Further versatility and operability is demonstrated by an example scenario involving NY bus stop display 117, linked to this venue/network/system and method. Employing the aforementioned data gathering and managing components 108, 109, 114, 115, a female passerby is converted to an engaged interactive ad target when she is profiled. In this case, the system has determined through data exchange with AT&T that her IPHONE 129 has several gambling related game applications downloaded to it. She is called by the display, thereby demonstrating the immediate custom content creation operability of the venue and display. She is solicited to engage in the NY STATE LOTTERY by using her voice and/or IPHONE to immediately select numbers for the lottery that is about to be determined, in 5 minutes from that moment she is solicited.

Continuing with this example, she is asked if she would like to play the lottery. When she replies, “yes,” the system confirms, “are you Susan Blake?” She says “yes,” and voice recognition operability managed by computing workstation 114, confirms her affirmative response. To confirm her identity, she is asked to refer to her IPHONE. The display has engaged, through Wi-Fi interactive exchange, her IPHONE to automatically display a system/lottery relevant display, to provide the “last 4 digits of her Social Security number” to play. When she does provide this, the “system linked” database of venue co-op partner, e.g., AT&T, confirms the digits, and she is permitted to select her numbers on her IPHONE and/or by verbal, touch, or visual cues between her and the display.

Continuing with the example, the user must give a final approval on her IPHONE to confirm that others have not impacted her selection of numbers, during her live interaction with the display. Her fee to play the lottery is preferably automatically billed to her AT&T phone account, (or other agreeable credit scenario accessible by the venue and/or lottery). She has also, allowed herself up to subsequent solicitations by the lottery for her to play, by way of interaction with her IPHONE and without display 105 interaction being required. This interactive exchange demonstrates at least the targeting, security options, transacting and subsequent selling that system 100 may provide to advertisers, and that is not possible with conventional prior art systems/networks.

Moreover, the same discreet targeting, sampling, interacting and selling options are employable at a small or large scale. For example, advertiser 125, MERCEDES, may use the active and passive targeting operability of the teachings herein to profile a plurality of targeted viewers 106 in the vicinity of a billboard located in Times Square, New York. Targeted viewers 106 may be profiled by electronic signal exchange profiling and/or other visual and/or other profiling techniques, as well as other factors which may be weighed by display sampled or system accessed information, (e.g., time of day, weather, season, or current events among a variety of other variables deemed relevant by system programming and computing operability to at least the advertiser featured).

The teachings herein provide additional value, by way of the interactive, content exchanging operabilities of the invention. For example: A dedicated “channel” on cable systems, such as multi-system-operator, MSO 121, allows for home television viewers to watch a “reality” show configuration of the interactive exchanges with target viewers, whether related to selected advertiser(s) or not.

For example, CHASE BANK, may not only sign up new checking account customers through display operability such as described herein and relative to displays 117, 107 and 116, but may create a “show” by asking provocative “spending” “money” related questions to display interactive targeted viewers 106. Targeted viewers 106 may appear on a dedicated CHASE channel, for example, whether on an MSO to home TV viewer 120, or by way of a home computer user viewer 122, who may be viewing the channel(s) that such a display network system may provide on YOUTUBE or other linked video display venues, such as those provided by Internet 104. For example, viewer 122 is in a coffee shop are licensed wirelessly to view several channels linked to one display network, by way of Wi-Fi linked computer 123. Through another operability of the network, this computer user may not only be a passive “viewer” of channels dedicated to content created at least in part by the display network and/or users and/or display targeted viewers providing content to it, but this viewer 122, may become an interactive participant. For example, he may provide feedback pertaining to a targeted viewer 106 and or advertiser, such as CHASE 124, which may even be provided to that targeted viewer 106 or others involved in the venue, including content providers and/or other target viewers, whether live and/or pre-recorded content.

For example, the lottery playing viewers 129 see on a display 107 that 12,594 home viewers and interactive participants, around the worlds, are watching her as she selects lottery numbers. They may even help her select the numbers, on her approval, based on collective and/or individual feedback filtered to the display 107 and/or interactive viewers, by hub information processor 101, or other ancillary content managing and linked computing operability. A home user, such as 122, may even appear visually and/or audibly on the display 117, seen by at least targeted viewer 129, and/or seen by other possible viewers of display network generated content 120 and a user. In essence, the advertising venue becomes an ideal multi-media social network, involving a plurality of participants, active and passive, providing further advertising and/or data gathering and other value to at least advertisers while providing social network operability and value, to viewers, be they active participants via computers, PDA devices and/or displays of the network/venue.

Interactive participants, such as those linked by at least one information managing network; such as the Internet to at least one primary hub information processor 101, may include: users of home computing devices 104; those interacting by PDA and/or other portable devices, such as cell phones 119; and people interacting publicly 129, 106, 111, via publicly situated computing/display device(s') operability as linked to the network, and other possible basis for interactive participation exist, beyond these examples.

Such display devices may be configured in many ways, including as phone kiosk displays 107, billboard displays 116, bus stop kiosks/displays 117, among many other possible shapes and sizes of publicly situated displays that include at least featured content, such as digital video images manifest as direct display and/or projected visuals.

Herein, a paying advertiser and/or co-op partner of example venue, is the television program, AMERICAN IDOL. This example advertiser 125 need not be a media product, such as a TV show, even a product maker like KRAFT could provide an aspect of the paying basis for aspects of the venue value and interactive configuration, however AMERICAN IDOL provides an especially good basis for a scenario demonstrative of important interactive and/or multimedia functionality and value provided by such a venue.

As an advertiser 125, AMERICAN IDOL provides at least content to the venue hub information processor 101. AMERICAN IDOL includes a live program aspect that is episodic. The venue provides via programming operability 110, an additional live program related to AMERICAN IDOL that is continual, with content within this continual live feed not necessarily all having to be live. In this example, this continual program is featured herein, on a dedicated channel via MSO 121 to home television viewer 120. It is also accessible as a YOUTUBE channel to laptop computer user 122, via his laptop and system linked computing operability such as laptop/Wi-Fi combination 123. This social networking and advertising display venue configuration provides a plurality of “channels” through television and/or the Internet and/or another transmission service, providing distinct revenue generating and/or entertainment purpose(s), including separate programs at least in part providing content and/or interactivity about, or beneficial to, at least one branded good or service 127, such as KRAFT.

For example, an individual in bus kiosk 117, is solicited by network targeting programming determination 210, to provide dialogue and/or transmitted feedback (such as via PDA 112) about cheese. In this scenario, AT&T customer 129, using IPHONE linked to AT&T, which is a co-op partner of the venue. The incentive that is optionally provided by the venue programming determination 110, is a redeemable credit registered on her IPHONE through a distinct application, and/or her AT&T account or other method meaningful to display to targeted viewer 129.

Home user, is also engaged in the dialogue involving the venue operability, about cheese. The user was searching for information about recipes and the venue data managing program(s) solicited this user to participate in the CHEESE dialogue, or “channel,” after determining a certain value to at least the venue, KRAFT, or another participant(s) in the venue. In this example, the interest level of the user was a key factor, as directing this user to the AMERICAN IDOL channel would have been more lucrative for the venue.

But, the computing operability of the venue determined a high likelihood of losing that user's interest by moving him too far off demonstrated/predicted areas of interest/preference thus the cheese dialogue trumped the immediate higher value to the venue of delivering the user to AMERICAN IDOL's channel. Indeed, this user thus remained as an interactive participant of the venue for another hour. If he had been delivered to the AMERICAN IDOL-related content, he would have disconnected from the venue and ended that day's interactive session.

User thus witnesses twelve viewers of venue displays, around the world, dialoguing and providing feedback related to issues around the topic, cheese (and at points, specific to KRAFT in this example, though not necessarily in all venue cases where KRAFT would be simply soliciting market data related to their “area” of commerce and/or objectives). User is invited to join a split-screen dialogue with display network viewer/targeted viewer 129, after computing/programming operability 110 has determined the user to be a high value participant to display to others, (such as other home computer and/or TV users and/or display unit viewers/targeted viewers). Other venue interactive participants as a result provide solicited information, in this case as to whether they agree more with the user or targeted viewer 129 with regards to a specific issue related to cheese. This automatically solicited and collated data is of value at least to paying advertiser, KRAFT. Further, all of the “face time” from all viewers/users, engaged in the channel and/or interactive exchanges related to KRAFT's venue involvement, is paid to the venue by KRAFT as their selected option of transaction. At least one other option was a flat fee to have a channel for a day, among many other possible selectively broad or discreet ad without targeting options.

Continuing with this example, when display targeted viewer 129 provides certain information that data managing operability 110, determines as a key profile aspect of her, she is considered a key targeted viewer for the AMERICAN IDOL interactive dialogue. She is solicited by venue interactive operability to join the social network dialogue related to selecting at least an AMERICAN IDOL singer, from a number of home and interactive participants who have auditioned via their interactive computing devices, such as via PDA/phone devices, such as mobile user 118 who has auditioned via SKYPE through his IPHONE 119.

Targeted viewer 129 finds herself engaged in a dialogue with a man, targeted viewer 106, who is interacting related to AMERICAN IDOL through a venue display configured as a phone booth display in a Los Angeles neighborhood 107 and through his PDA device 113. Though, initially targeted viewer 129, was only watching targeted viewer (male) 106, on the display as he was interacting with others, she was periodically solicited on her PDA 112 for specific feedback information relative to what she had been watching and those targeted viewers' content/opinions/feedback. Those solicitations were generated at least in part by hub information processor 101 as triggered by one or more programming parameters 110.

Continuing with this example, targeted viewer 129 had accrued over $5 in redeemable venue dollars for later redemption by providing her reactionary information. Accordingly, she can accrue much more as a selected, channel display participant, being seen, in this example, by tens of thousands of others who are viewing and/or interacting in the AMERICAN IDOL interactive network, which is at least also featured in this example as a channel on a cable system MSO 121, and/or an Internet web site feature to users, such as user 122 via Wi-Fi computing and laptop components 123. She is also being seen by many via other venue public displays, such as the AMERICAN IDOL dialogue being featured on billboard 116, in Times Square, New York. That particular feature is paid specially by AMERICAN IDOL 125, as a premium display, which allow for numerous participants in Times Square to interact with the media/display, through wireless computing devices, such as display viewer 111's PDA device 113.

Further, in accordance with the teachings herein, an episodic television broadcast/production, provided over a variety of transmission options, may be affected at least in terms of content by the interactive venue exchanges and/or content creation, occurring during, or at times other than the live (or not live) broadcast of show elements of AMERICAN IDOL. For example, pre-recorded and/or live provided information and content, such as images of display targeted viewer(s) participating interactively, may be included within the content of the show being seen by many millions of people; increasing the excitement for those at displays, becoming potentially featured within the worldwide viewed TV production/show.

For example, a woman in another country may become a guest judge on the show, AMERICAN IDOL, literally viewing the participating singers and providing feedback, as she is (optionally) also seen and heard on the live TV show watched by millions, as well as via simulcast of her provided content within the internet and other aforementioned continual IDOL channels, (or selectively continual, relative to the timeframe of the episodic production seen by millions mostly via TV cablecast and broadcast).

Further, such featured information and/or content derived from interactive system/venue participants, whether at home, via PDA devices, phones and/or display unit component operabilities, (including video and audio capturing and conveying devices linked to the display units) may become integral to the interactive feedback collection critical to data sampling priorities of AMERICAN IDOL producers and/or others linked to the display network/venue and/or the venue/system itself and its own database operability and value 110.

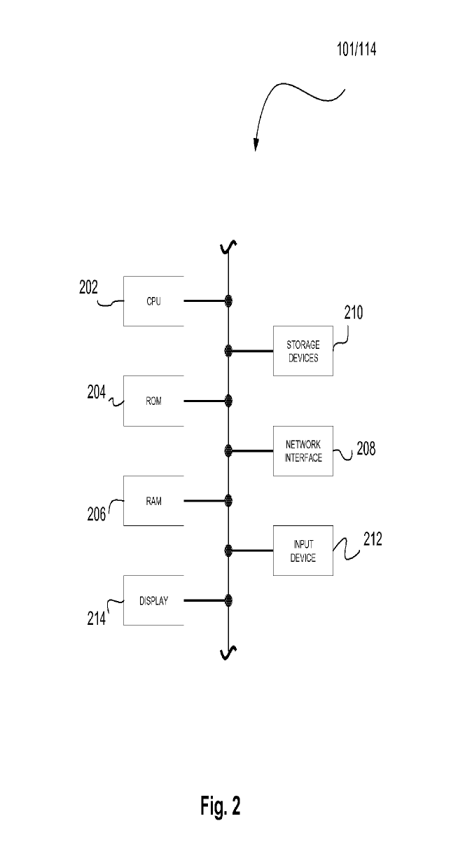

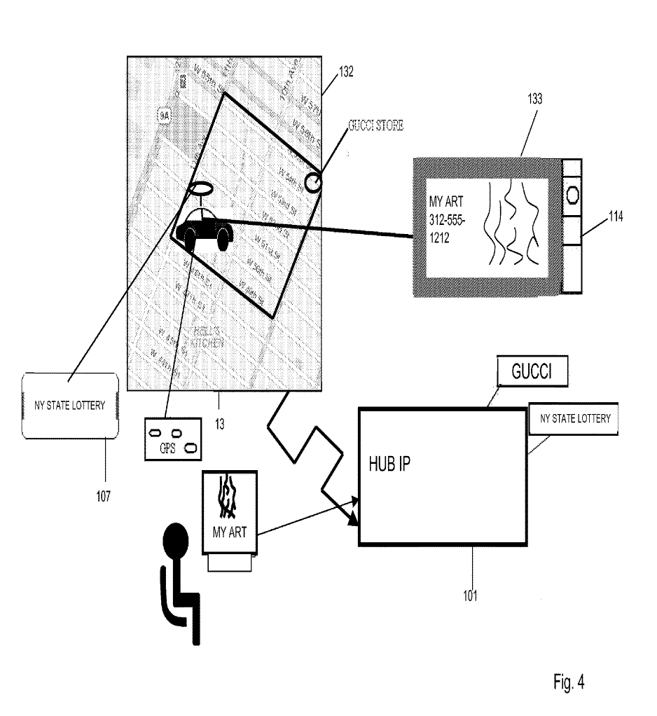

With reference to FIG. 4, an example including operability pertaining to one or more display(s) in a moving vehicle, such as a taxi, feature advertising, internally and/or externally. Mobile advertising containment, in this case vehicle 131, includes two exemplary mobile display units of an example venue, distinct from or related to that featured in FIGS. 1 and 2, including vehicle 131 and its location variable display 132. Herein, taxi 131, features content related to a content provider who has uploaded at least a media file to the hub information processor 101, and designated at least one targeted viewer advertising priority resulting in the inclusion of at least one mobile display, in this case a network/venue linked taxi with an interior display 133.

In this scenario, the interior ad display 133, includes targeted viewer 106, (taxi cab passenger(s)) and passive and/or active identifiers, as those described above. Further, the display 107 on top of the taxi also has targeted viewer identifying operability linked to computing operability within the taxi, which is wirelessly linked at least to hub information processor 101. In this scenario, content provided on external display(s) 107 is variably based on one or more parameters, including the position of the taxi/display relative to defined regions; in this example, sections of New York City.

For example, display(s) 133 are linked to computing operability, in this case occurring locally (in/on the taxi), and via hub information processor 101. When the taxi/display(s) enter prescribed locations, defined by venue programming based on parameters which may include general demographic expectations and/or specific advertising/targeting criteria, (such as proximity to a paying advertiser's storefront), the display may vary and/or alter the content displayed as a function of targeting advertising and/or soliciting information or other valued venue objective.

Within the taxi, a targeted viewer passenger, may be profiled physically (e.g., visually, audibly or otherwise, etc.) and/or electronically, (PDA/Phone transmissions or other electronic transmission or reflective signal gathered and analyzed by component(s) of the system/method/venue). Thus, the additional variable of location of one or more mobile displays may be determined by GPS operability, providing location data to computing component(s) of the venue, such as those mobile with the taxi and/or hub information processor 101. Accordingly, location data may thus impact content targeting options for content providers, such as advertisers, and content displayed, as determined by hub information processor 101, at least in part based on the targeting objectives of content providers, based on this provided operability.

One example of this series of system components includes the store GUCCI having provided content to the system/venue as advertising, along with targeting criteria. Within system parameters and priorities, the GUCCI requested parameters are confirmed in a series of venue displays 107 that feature GUCCI content for one day in New York City. Beyond phone and bus kiosk displays, all taxis driving up Park Avenue from 72nd street to 77th street, are targeted by the venue under the agreeable GUCCI transaction, to display the GUCCI ad on top of the taxi; the GUCCI flagship store is on Madison Avenue and 75th street. The content and displaying parameters, determined as a function of programming operability are conveyed wirelessly, to the network computing workstation 114 from the hub information processor 101, which preferably reside on/in the taxi, and is linked to the displays, including on top and inside the taxi.

Continuing with this example, a special targeting parameter is included, which electronically identifies targeted viewers 106 walking on Madison Avenue between those designated GPS confirmed blocks, and who agreeably allow their identities and outside data sources to be accessed based on their cell phone signals. For example, a special incentivized arrangement of three wireless network “co-op partners” participating in the venue advertising/interactive program have agreed upon business terms. Further, the targeting specificity provides, in this example, a special change of GUCCI content on the taxi display 107 to occur when a selectively strong and/or positioned transmission (from a targeted viewer 106, for example) is identified by signal receiving operability onboard and linked to the display components of that taxi. Such changed content involves onboard display computing component(s) 114, and cross-referenced against at least one database, by computing operability.

Continuing with this example, such cross-referencing reveals a female luxury goods purchasing targeted viewer 106, based on preset criteria within system/venue programming component(s), a specific, expensive handbag image is transmitted and/or triggered to be displayed on the taxi's external display(s) via taxi computing operability 336, in this instance, until the taxi crosses from 77th street to 78th street, on Park Ave, or when the signal from acceptable targeted viewer(s) meeting the specialized display criteria reaches a preset weakness of signal and/or distance from the taxi display(s).

In essence, the value and potential revenue from a single display is enhanced, by making internal vehicle and external vehicle displayed content “regionally relevant” to passengers, those seeing vehicles pass by, or other applications of displays that may not be fixed to one location, such as due to functionality of the display carrying component, (in this case, the taxi itself). In the GUCCI example above, fees earned by the venue may be based on a unique combination of sampling factors met and/or targeted, such as fees per identified and verified, criteria-meeting targeted viewers counted during taxi time within the regional target zone, in this example, particular blocks on Park Avenue.

Such operability has application for a myriad of linked public and private transportation options. For example, subway advertisements, whether display-only or interactive, may alter based on the subway stop they are approaching and/or, based on system computing tabulation of criteria met by passengers within or outside subway car(s) and based on the active and passive sampling options, such as cellular telephone phone signal identification, which may be cross-referenced against other databases linked to the venue/system. Further examples may include outside (or interior) visuals manifesting electronically or otherwise on airplanes, which may alter based on a particular airport, among other similar variable location-based, venue/advertiser valued options.

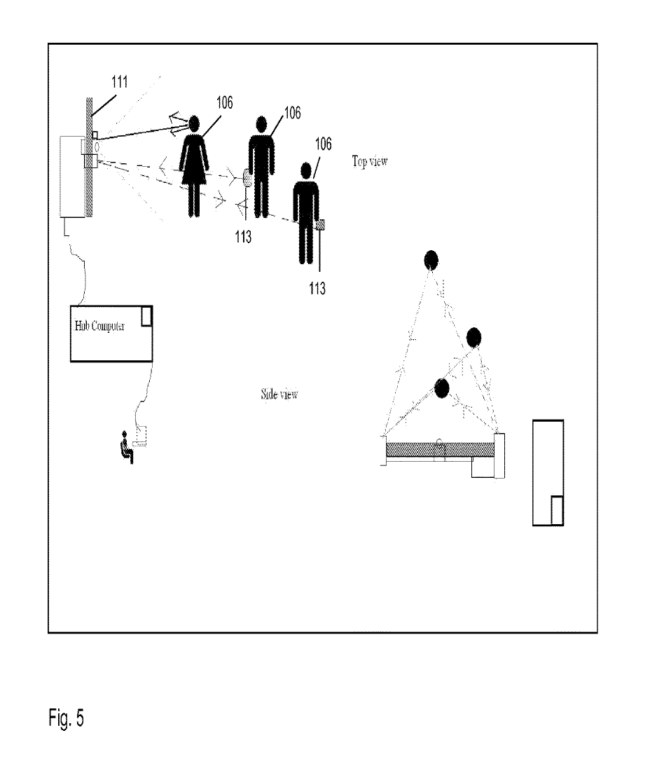

Referring to FIG. 5, interactive operability aspects that relate to profiling targeted viewers 106 and focusing and/or customizing content options displayed on a unit(s) of the venue. As shown and described, targeted viewers, are within a system relevant proximity to the aforementioned Times Square display/billboard 111. In an example scenario, a plurality of viewers, in this case three, are profiled by a range of device-related identification signals.

Display proximity measuring components 109 determine through options including reflected/bounced signaling technology and/or local (or remote) cellular signal positional profiling/measuring and/or visual cue analysis involving visual information gathered by at least one or more imaging device(s) 108 positioned on and/or near the display. Other targeted viewer positional measuring approaches allow data to be provided to display data managing computer/component 403 (workstation 114) are also acceptable alone or in tandem with the approaches described.

Further, visual or other sensory cues, collected by the physical property sampling component 408 and/or imaging device 406, provide information that is managed as data by local workstation 403, and/or conveyed directly to hub computer(s) of the hub information processor 101. This visual or physical data related to targeted viewer(s) and/or information gleaned by cellular or other identification signals, such as sent by PDA, phone or other targeted viewer related devices 130/407, provide all or part of the information basis for profiling targeted viewer(s) involving at least local and/or remote computer(s) 101/403.

For example, targeted viewer 106 is determined to be a female and closest to the display 107 by components including, camera 115 and reflected signal measuring component(s) 404 and/or 405. The targeted viewer is further determined to be of a certain designated “type” of female based on visual cue criteria captured by imaging unit 406, and recognized by programming/software operability managed locally by workstation 114 and/or hub information processor 101.

Continuing with reference to FIG. 5, two other targeted male viewers 106 are determined by local recognition of their mobile devices 113 to affect the selection and/or modification of displayed content. For example, one targeted viewer 106 had previously released data under an agreed arrangement. The venue has access to a plurality of external databases, related to that targeted viewer's 106 shopping and behavioral history. The other targeted viewer 106 is solicited by his BLACKBERRY, which is in communication with the display 107, to select an icon to allow for such release of information. In this example, he does not release this information, which itself provides the venue/system with some data relevant to the targeted viewer. Thus, a MERCEDES display occurs as a function of programming 110 executed on hub information processor 101, selecting from available content from at least advertisers, based on a tandem profiling result of these three targeted viewers. The males tabulated profile results, from available and accessible information, determined the brand/image(s) to be displayed, which included other criteria such as “relevance and potential interest” to the targeted viewers, beyond the potential ad revenue to the venue; thereby maintaining an interest in the display as one example criteria of content selected and displayed by the venue.

Continuing with reference to FIG. 5, the influence of the female targeted viewer 106 was factored according to variable prioritizing programming within software/programming component(s), at least including component 110. The result is that the visual of the MERCEDES content was the particular car model that was determined most valuable overall to display in the tandem factoring of variables related to targeted viewers and/or advertiser(s) priorities. As a result of this example of customized content selection and management operability, enabled by a network and system, the MERCEDES model was digitally modified as digital data managing operability managed by hub information processor 101, and conveyed to the display. For example, the digital modification turned the black MERCEDES car image to red, determining that this color would have greater impact and result to these targeted viewers. Had the female not been the closest to the display in this one example, the car would have remained black or turned blue, depending upon whether the other targeted viewer was nearby.

Thus, demonstrating the substantially immediate collection, collation and affecting of information by, in this case the hub information processor 101, in providing what the system deems to be the highest value potential content based on, typically, a plurality of valued criteria relevant to, typically, a plurality of parties, in this case, the targeted viewer(s), advertisers, and the system priority of maintaining viewer interest and viewing time.

It is known in the field, that “eye time” on a certain visual display can be measured based on a number of criteria and measured aspect(s). Herein, that operability is improved by literally assigning such measured “eye time” to specific, profiled viewers. For example, if one targeted viewer views the display for ten seconds (as measured by imaging component 406, or other components configured to “see” and measure pupil time on the ad), the advertiser, MERCEDES, may be charged at least a fee based on a given level of targeted viewer value and a measured amount of time viewing the display.

Thus, a “level 2” targeted viewer viewing for “over 5 seconds” may be billed as $1 to MERCEDES, whereas the female viewing, with no external database correlation means, bills only “five cents” to the overall targeted viewer success transaction aspect/option(s). The aforementioned measuring of interactive involvement criteria, occurring between targeted viewer(s) and display(s), may be enhanced beyond the verbal/visual/PDA and other options disclosed previous, herein, by “eye time” on any given display, measured by display component(s) situated on, by and/or near the display. And, again, factoring of “eye time” by a specifically value-ranked targeted viewer, may further affect the discreet measuring and transacting, based on delivering targeted viewers at agreed thresholds of engagement with the displayed content, for example.

Further, other more direct interactive possibilities, such as whether verbal interaction with the display facilitated by “audio and/or video capture and data managing” by the displays component(s), or by interaction via separate and linked computing devices, such as IPHONE 130 may provide other, distinct basis for transaction based on “advertising” priorities, “data sampling/focus group information” collected, interactive time providing content creation for separate use, such as a show like AMERICAN IDOL, among other improved functional and correspondingly more discreet and layered transactional options.

The computing operability of system 100 manages via system specific programming 110 a unique combination of information and content aspects, variables and potential instructions. These are provided to and from at least content providers and displays 107 of the network, with additional interactive content and/or data exchange occurring with linked computing devices peripheral to the network.

Further, the system manages options by specific and key operability aspect(s). For example, components gather data from/about at least viewers of network displays, collected by electronic signal and sensory information sampling devices linked to display(s) such as visual, audio, olfactory/odor and provide one category of data. Even physical sampling, including facial recognition visual sampling/data managing, may provide data for targeted viewer profiling. This information may be relevant, for example, for advertisers of the display network or other data providers and individuals engaged in social network/communications activities, as a function of network-linked computing options/accessibility. For example, a fair, blue-eyed viewer may be targeted selectively with different network content for display/presentation than a dark skinned, dark-eyed viewer. Even acne, for example, may be programmed for visual detection as a potential network priority, allowing a selected degree of acne probability relative to a viewer to affect network computing content determinations for at least one display linked to the network.

Adjunct data, such as weather occurring related to a display(s) season, and other display “condition” variables may further be weighed by system computing. For example, such variables may be used in the selection of content and/or modification of content to be displayed at a given time.

Further operability herein, includes system computing functionality to correlate, select and/or manage the exchange of content, including content featuring images/audio of or related to targeted viewers and/or other interactive participants of the venue, such as home computer and PDA users who are linked in to the network. For example, a “channel” of the network including a system determined number of display monitors and/or home computing devices may be managed to be included in an interactive scenario of the venue.

The selection of such units may provide an interactive basis for at least preset criteria to be employed in at least prompting and presenting interactive participants to other viewers, whether they are interactive participating viewers or not. Managed selection of participants and/or content to present, and/or managed content relative to participants, may occur via at least advertiser priority data. Data may be linked, at least, to transactional information relative to meeting the advertiser priorities and/or targeted viewer and/or interactive participant(s) relevance. Such relevance may be further affected by system parameters relative to other interactive and non-interactive viewer(s) aspects, including those actively and/or passively sampled in real time. Thus, relevance is a factor at least as an option to maintain a targeted viewer, user, and/or viewer engagement with aspects of network presented content/information, in accordance with an embodiment.

FIG. 2 illustrates the functional elements of an example information processor 101 and/or workstation 114, and includes one or more central processing units (CPU) 202 used to execute software code and control the operation of information processor 101. Other elements include read-only memory (ROM) 204, random access memory (RAM) 206, one or more network interfaces 208 to transmit and receive data to and from other computing devices across a communication network, storage devices 210 such as a hard disk drive, floppy disk drive, tape drive, CD ROM or DVD for storing program code databases and application data, one or more input devices 212 such as a keyboard, mouse, track ball, microphone and the like, and a display 214.

The various components of information processor 101 and/or workstation 114 need not be physically contained within the same chassis or even located in a single location. For example, storage device 210 may be located at a site which is remote from the remaining elements of information processor 101, and may even be connected to CPU 202 across communication network 104 via network interface 208. Information processor 101 and/or workstation 114 preferably includes a memory equipped with sufficient storage to provide the necessary databases, forums, and other community services as well as acting as a web server for communicating hypertext markup language (HTML), Java applets, Active-X control programs. Information processor 101 and/or workstations 114 may be arranged with components, for example, those shown in FIG. 2, suitable for the expected operating environment. The CPU(s) 202, network interface(s) 208 and memory and storage devices are selected to ensure that capacities are arranged to accommodate expected demand.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, MYSQL and PHP.

Although the present application is described by way of example herein and in terms of a web-based system using web browsers and a web site server (e.g., information processor 101), system 100 is not limited to such a configuration. It is contemplated that system 100 is arranged such that display 107 communicates with and outputs data received from information processor 101 and/or workstation 114 using any known communication method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on information processor 101, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

The present application is now further described with continued reference to FIG. 3.

Display viewers (“targeted viewers”) 106 and 129 are preferably profiled in relation to their electronic PDA transmissions 112/113 and/or physical aspects/situations by display unit hardware, such as targeted viewer profile collecting components 108. These data are converted to system relevant electronic data and conveyed by display computing operability workstation 114/403, accordingly. Visual and audio data may be collected, including visual information that is converted to electronic (e.g., digital) signals by display unit cameras 108. Hub information processor 101 may receive and sort and/or categorize such data according to parameters programmed as aspect(s) of network programming/software component(s) 110.

For example, a home computer user who is a network paying content provider transacts for content to be distributed by way of computing device 103. Display network purchasing options are selected and received by hub information processor 101 in accordance with at least updated network availability data, managed in accordance with operability via programming 110. Non-paying interactive participants 122 and 118, view and interact with the network via wireless and/or wired connectivity, for example, via their computing device components 123 and 119.

Continuing with this example, brand name advertisers 125 provide national placement requests to hub information processor 101, and have confirmed content related options in response to prompts and information requests provided by hub information processor 101. Brand name advertisers 125 have provided a myriad of location, situation, condition (e.g., weather) and targeted viewer trait and preference criteria, among other possible criteria, associated with content purchase requests. Hub information processor 101 collates such requests against updated network display availability as weighed, for example, against other network priorities, and provides confirmations and/or revisions and/or suggestions for confirming and/or revising content requests by the advertisers 125 to arrive at an agreed-upon and confirmed transaction.

As a result of profile information relative to the targeted viewers 129 and 106 and/or other display and/or display viewer/targeted viewer relevant variables valued as aspect(s) of programming 110, targeted viewer 129 is solicited (by display 117) to allow for the release of personal information, via her cellular provider, AT&T. As a result of at least this information, hub information processor 101 determines that targeted viewer 129 satisfies network valued criteria related to a likelihood to gamble and spend on reward based opportunities. Network data managing functionality further determines that the NY STATE LOTTERY, although a less lucrative advertising proposition for the network than KRAFT (who values targeted viewer 129 highly) per second of “eye time” and designated interactive billable criteria, selects NY STATE LOTTERY for providing content to targeted viewer 129.

Continuing with the present example, network criteria related to interest and relevance to maintain interactive session time with the targeted viewer, as well as criteria related to subsequent intentions determined by network programming relative to targeted viewer 129 and her value to other network priorities including at least one other advertiser, leads hub information processor 101 to select the lottery advertiser 125 as the interactive advertising basis to next present to targeted viewer 129. Though a simple visual(s) related to this selected advertiser might be presented non-interactively, to simply expose targeted viewer 129 to a respective advertisement message, in this scenario the targeted viewer is verbally and visually solicited by display 117 to transact financially and “play” the lottery via that display 117. Camera/audio capture 108, captures video and audio, at least, of targeted viewer 129, and relays this video to hub information processor 101 for potential use for purposes other than targeted viewer profiling bases.

Herein and based at least in part on interactive information exchanged with display network interacting targeted viewer 106, network data managing 110 determines that “Jenny,” targeted viewer 129, is next best solicited to participate in a network interactive advertising venue relative to advertiser 125 (AMERICAN IDOL) and as a network-featured “content aspect” with at least targeted viewer 106, who is now having his image and audio captured and conveyed to the network via display 107 operability including data managing workstation 114/403. Moving Jenny to this new interactive opportunity is valued by the network at least in part based on the value to other network participants, including non-interactive network related content viewers including those viewing content that will include Jenny 129, within Internet content viewing venue(s) and/or television viewing venue(s) including, in this example, the live broadcast/cablecast of AMERICAN IDOL to television audiences on FOX TV, FOX being a network linked, content partner by way of the AMERICAN IDOL 125, transaction(s) with the display network.

Jenny is solicited to interact, relative to AMERICAN IDOL, with at least other display network interacting targeted viewers 106. Also interacting and relative to network-provided content and interactive prompts that are at least in part generated by hub information processor 101 is home Internet user 122 who has a web cam and has the potential of being valued vis-a-vis parameters managed by hub information processor 101. Such valuing may result in user 122 being included visually, via web cam and audio capture, in networked content provided to at least one other network viewer and/or interactive participant, such as targeted viewer 106, if not provided to many others.

Many such interactive venues may be managed by the network and that provide a plurality of channels and/or groupings of interactive participants, including displaying targeted viewers and/or others linked to the network. Such groupings, may be determined in part based on network priorities, such as paid advertising targeting requests for ongoing revisions to interactive participants to provide and/or prompt network operability to provide information and/or content to the network (via network display(s) functions or home or other computing devices).

For example, cellular PDA user 118 is solicited, based on interactions and/or profiled information factored by hub information processor 101, to join in an interactive dialogue and video sharing via his cellular device. Prior to the prompt to participate in additional interactive network options, user 118 is viewing related or soliciting content featuring other participants, including targeted viewers 129 and 106, whose video and audio is provided via network displays' components and operability. The content may be wireless information distribution and/or linked distribution, via a cellular provider and network coop partner, AT&T). Previously, targeted viewer 106 was solicited with an AT&T related point incentive to join the interactive AMERICAN IDOL 125 related “game” and/or discussion, via his PDA device. He was also able to join the AMERICAN IDOL related channel by simply touching display 107, engaging its touch-screen interactive operability, though wireless, audio or even video commands that also included interactive options, by simply moving his hand to engage a displayed selection by targeted viewer 106.

Thus, the teachings herein provide advertisers with unique targeting, data gathering and exposure opportunities, via displays 107, to interactive participants and non-interactive viewers of networked-provided content. Some of the content may be generated by interactive participants, including by operability of the public display devices linked to the network. In this embodiment, system 100 allows display targeted viewers and other computer users to dialogue and even impact “who” is searched and connected to them, via network operability. In the previous example, PDA user 118 ended up in a dialogue with another network interactive participant when he engaged in a “search” based on his own criteria, which resulted in the network providing and/or steering him toward at least one other interactive user. Thus, a live connection may be provided between 118 and another user, for example, a home computer user 122, even though PDA user 118 may have been under the impression that the only connection shared was an interest in the AMERICAN IDOL 125 related interactivity and/or issues(s). Hub information processor 101 based on programmed priorities 110, identified 118 as a good candidate to quietly “steer” user 118 other information and linked network participants, based on paid priorities of an advertiser otherwise unrelated to him beyond their initial AMERICAN IDOL 125 interactive involvement. As a result 122 and 118 ended up exchanging feedback related to the art of a paid content provider.

Information exchanged and/or gleaned by the network operability related to at least one of 118 and 122 is valued by at least a user and/or the proprietor of the teachings herein. A content provider may pay for information and/or “eye time” from interactive targeted viewers who meet selected criteria threshold(s) sought by the content provider. Further, in this case, network priorities maintained as aspects of data managing 110, determined that at least one of 118 and 122 would maintain interest in the network steered shift to the issue of “art” based on data pertaining to at least one of 118 and 122 gleaned during the AMERICAN IDOL related interactivity and/or other accessed and/or exchanged information related to 118 and/or 122.

Continuing with this example embodiment, 118 was steered toward the more lucrative art advertiser, a branded art gallery featuring high priced art. He may end up not transacting relative to the content provider's art, although the provider may be charged for network delivery of that targeted viewer to his content. In this example, user 118 purchased a high priced piece of art from a brand name advertising gallery advertiser 125 of the network, that was also charged for at least delivering targeted viewer 118 to content of that gallery, as a function of network-steered advertising and/or social networking functionality. Thus, the networked provided a plurality of functions to a myriad of viewers and participants, resulting in targeted viewer(s) being subtly maneuvered toward other network valued content connections, in this case, while maintaining relevance, or at least the illusion of relevance and control, to the user(s). In this example and relative to interactive participant 118 was engaged in at least viewing AMERICAN IDOL-related content created at least in part by display units' media capture operability as managed and conveyed at least in part by hub information processor 101.

The present application includes a range of improvements to known and available social networking, advertising and public display options. Networks created to include aspects of these improvements may include computer-managed streams of information and content between computing devices of and linked to such networks. These include data managing systems coupled to public displays that receive display-specific content from hub information processor 101. These also include an optional exchange of content targeting information, to and from at least computing devices linked to the displays.

Further, each media contributing display/computer of and/or linked to the network may provide data manifest as content, or aspects of content, viewed on other displays of and/or linked to the network. Interactive operability enables individuals to dialogue and/or become captured as media aspects exchanged between interactive users of and/or linked to the network. Further, those linked to the network may receive information and/or content for non-interactive viewing, though subsequent or concurrent interactivity may occur via separate computer facilitated interactivity by such viewers. Moreover, improvements include at least home computer user, PDA and/or cell phone users who are accessible to submit content for networked display 107 in a public, visual display network. Display-specific versatility allows for extreme specificity, as narrowly targeted to a single display presenting a single submitted piece of content, as submitted and/or modified, and selectively displayed at one or more time(s).

Thus, the teachings herein provide for social networking operability involving displays of a public displays venue/system. This includes operability to allow remote users and/or viewers of display(s) of the venue to become content aspects of content displayed on as few as one display, or as many as all displays of the network, including those that are external to public display units distribution of venue generated content, including cable television and/or internet distribution. Such external distribution may include uni-directional content conveyance and/or interactive exchanges of content and/or information related to conveyed content.

Active and/or passive system profiling of display venue viewers and/or other interactive participants of the network, including home computer and PDA device users, is also provided. Such profiling data selectively affects network computing results, including the selection of information and content for relaying and/or modification and relaying to other display(s).

System operability further provides for a plurality of “channels” and/or distinct programming, including at least different grouping(s) of venue public displays and/or other viewers, such as home and PDA device viewers and interactive participants in venue related content. Moreover, home and remote users may search for people, including viewers of display(s) of the network, by providing search criteria such as trait and/or preference information related to such viewers.

Further, focus group data may be collected from interactive information solicited and/or otherwise provided to the system computing hub. These data are preferably provided by at least viewer(s) of public displays of the venue and/or linked content distribution and accessibility, such as television and the Internet. Moreover, system identification of viewers, subject to viewer targeting criteria computing operability, allows for cell phone and other viewer transmissions to identify at least one aspect characteristic of a potential targeted viewer. This aspect of information may be used to identify other information related to the viewer, including information from accessed from external database(s). Such information accessed may occur with or without the permission of the related targeted viewer(s). In addition or in the alternative, viewer targeting criteria computing operability is provided that includes an optional generation of system-relevant data captured from sensory stimuli, such as visuals, audio and/or fragrance/odor. As noted above, these physical stimuli may be captured by component(s) linked to display(s) and processed by computing operability linked locally to display(s) and/or related to system/venue hub computing and programming.

Network display(s) may be employed by system computing to conduct interactive exchanges with viewer(s), whether included with content provided to other monitors/displays of the venue or elsewhere. These exchanges may include transactions, solicitations for information and subsequent access to the targeted viewer(s) and incentive related programs and/or games related to display targeted viewers among other options.

Photo-booth operability may also be provided, thereby allowing public displays to capture at least visual information of people/viewers in the vicinity of a display, to convey such video at least to the display viewable by the viewer(s) captured visually and/or other display(s) and/or content distribution system(s). Such personal incentives, including experiential content exchanges such as images of viewers, may subsequently provide incentive bases for acquiring contact information from such viewers, such as cell phone number and/or email address, to provide the content incentive and/or linked incentive. Such incentives may be linked to information thereby providing transactional and/or incentives designed to maintain user interest in displayed content and/or to fulfill other system/venue objectives. Moreover, video and/or audio messages may be captured, as an interactive option is made known to viewers by display(s) of the venue. Subsequent transmission(s) of captured video, for example, may be provided to other devices in live or recorded media, including media provided to a viewer and/or system designated recipients (or interactive participants) such as family and/or friends. Furthermore, interactive display options, including touch-screen and/or other visual interaction with display(s) of the venue, allow for quick and easy non-verbal information exchange. Verbal, wireless transmission and/or other additional information exchanges may be among other targeted viewer to system interaction.

Sensory exchanges may further include purposeful interactive options, such as “breathing” into a collection component linked to a display, for breath analysis, in order to provide profile and/or social networking linking information to system computer(s). These options may further include DNA analysis of material related to a viewer(s) collected and analyzed by system/venue component(s). Further, retinal scans and other physical profiling of visual, audio and/or biological aspects specific to a viewer demonstrate the range of personal profiling/sampling options the system may employ by way of enhanced display operability, provided by linked components local to the display(s) site and/or remote to such displays/sites.

Such information may allow for selective connection between display viewer(s) and other information and/or other individuals, presented within content and/or live or recorded media. Further, such information may be conveyed for subsequent use by viewer(s), and include options, such as providing network-generated information and options to the viewers' wireless devices or other viewer-linked computing devices. Providing permissions and/or other instructions for the venue and/or brand(s) to contact at least the viewer interacting with the venue, is further facilitated herein.

Experientially-based content exchanges may link a plurality of display viewer interactive participants and/or other interactive users/viewers, such as those using home computers and/or wireless devices. Such exchanges may further be linked to games or other interactive bases for maintaining interest and interactions with and/or via at least the network displays.

Further, the purchase of content within a display network/venue may include targeting by location, by price, by time, by target viewer(s) desired, among other discreet targeting means. These are enabled in part by the system operability in profiling targeted viewer(s) in the vicinity of display(s). Incentive examples may include credit linked to coop partner accounts, such as linked phone company accounts of cellular telephone devices of display venue viewer(s), as well as accounts of partnered companies associated with, or desiring association with, targeted viewers.

Moreover, zone specific location options for acquiring venue media, include displays that are not fixed, such as those linked to vehicles including automobiles. Such venue media may include interior and/or exterior vehicle display(s), which display content based on the geographic zone(s) in which the vehicles are located, as well as the option for ongoing targeted viewer profiling, inside and/or outside such vehicles and/or display bearing component(s).

Thus, a computer-based system for linking customer information with information related to a specific item, product or service is disclosed herein. One embodiment includes a data embodied and or provided device compatible with at least one component at a point of purchase, such as a newsstand, and that provides initial components for customer tracking. This system preferably captures otherwise forgone information and that may be useful for subsequent incentives, such as follow-up issue(s) that such point of purchase customers might receive in exchange for providing or releasing data related to themselves. For example, a PDA device component, including the possibility of a cellular telephone mechanism may transmit at least phone number or other system compatible customer linked identification information. This information may be received at the point of purchase by a second computing component, which may be linked to a billing component for that point of purchase component. An interactive dialogue between these components may result in the point-of-purchase scanning the barcode of a single issue of the publication, with aspects of this transaction being displayed on the PDA device of the purchaser by way of wireless transmission and/or purchase or span of the related barcode. Such a purchase through this customer-identifying system might be associated with a specific application embodied within and or through connectivity of the customer's PDA device, or other electronic device, or other system-related data in an embodying component.

An example transaction, among many possible configurations of transactions facilitated by the present invention, is as follows: A customer walks into a newsstand store. He decides he wants to purchase a single issue of the magazine, ARCHITECTURAL DIGEST. By activating an available or accessible application on his IPHONE or other customer linked device, the customer makes ready his data managing and or embodying device for an anticipated exchange of information related to this magazine purchase. For example purposes, this “magazine (or other product) tracking example is referred to as “Smart Stand,” or “SS.” This is a multi-computer based, interactive system involving at least hub information processor 101 and a remote device, and at least one product identifiable by an aspect of the product, such as a marking or data transmissive/reflective aspect incorporated within the product and/or that product's packaging.

Continuing with this example, when the SS application is activated, the interactive exchange of information between the newsstand based data managing device, or devices, and the IPHONE begins. When the single copy purchase is registered from a barcode scanner, for example, by a newsstand-based component and/or a scanning operability within the IPHONE, options for purchase may be part of the information to be confirmed by the customer. Included among these options are a customer conformable command via his PDA device to allow the purchase the item to be built or in some other way integrated into an existing credit and/or billing account such as his IPHONE monthly bill. Beyond this option, the possibility of cash or credit card payment at the point of purchase may also be supported. One objective of the system is to link the purchase of the specifically identified item, in this case an issue of a printed magazine, with a specific contactable individual. Herein, the example of a cross marketing partnership between IPHONE, AT&T, and a selected group of point-of-purchase retailers and publishers demonstrates how an incentivized single copy magazine sales may provide a customer name and contact information to the publisher of a purchased magazine. Bar codes may include additional information, such as specifying actual items and not just product types. Thus, the single magazine purchased by the customer here, has a unique bar code or other product identifier, to facilitate the correlation between item and purchaser or customer at least interested in the item or otherwise targeted for incentives and/or information by the maker or cross marketing partner of the makers of that item.

Another example configuration of the SS system/method includes the aforementioned bar code being replaced by a wireless data transmissive and/or reflective aspect, accessible by a remote device (such as the customer's IPHONE) either at any time the item and device are linked by proximity or customer command, for example. Moreover, the instigation of data exchange between the item and device may require the alteration of an aspect of the item and/or its packaging. This may be as simple an action as breaking a plastic seal, removing a card from the magazine, or other physical (preferably permanent) change to the product and/or its packaging. In removing a perforated card, for example, at least an aspect of the data providing component related to the magazine/item is triggered. For example, one or more wires or other data triggering switch or alterable aspect may be broken or otherwise moved/altered, thereby triggering a temporary accessibility to data specific to that magazine by the external device(s), such as the system-linked IPHONE and/or a computing aspect at the point-of-purchase, also linked into the SS system and method. Such point-of-purchase computing may work in tandem with customer identification by electronic device, such as the IPHONE or other device, such as a credit card, driver's license, incentive card/bar code, or other customer info bearing/accessing identifier; whether a physical item or exchange of electronic data.

In this way, value is created to all partners of this network. The point-of-purchase is enabled to sell more items, such as magazines, as facilitated and incentivized purchasing of magazines is provided beyond the conventional cover price for newsstand magazine in the prior art. For example, the present application allows for a purchasing customer to realize his value from the network, system and method, by receiving at least one subsequent issue of that magazine or another incentive item. This customer, as a result of this operability, enjoys immediate and/or subsequent incentive items of value and even possibly value beyond the cover price of the initial purchase. For the publisher, the value is significant. Once unidentifiable newsstand buyers are now identified for publishers. For the publisher, not only will this allow the purchaser to be counted within its subscribership for that issue, but subsequent incentives and communications agreeably allowed by the customer may result in a high probability of subsequent subscribing to the magazine, in general, by way of these communications.

Any data embodying component provided by a customer, and even those that do not transmit data wirelessly, may also function to provide information and linking operability of the present application. For example, the purchase of the same magazine also includes scanning of a credit card, drivers license or other personal identification device which maintains a direct or linked information data visually, magnetically or otherwise within its containment. This may include such devices that provide data when in proximity of compatible signal transmitting and receiving devices, such as those commonly used to extract data from customer units for automated toll collection, speed pass charge cards, implanted pet ID chips, or the like. The customer agreed-upon release of identification information, from across marketing arrangement with their credit card or other payment and or identification holder provides the means for the publisher of the magazine to receive, and use, selected identification, contact, and/or other information from such system compatible providers.

Preferably, the present application is a data managing network involving at least two data managing components working in tandem to facilitate the exchange of customer data. This, in conjunction with customer payment for items, provides subsequent and/or immediate incentives at the point of purchase including those which occur as ancillary electronic transactions benefitting in the customer. Such incentives are logically geared to reward customers for agreeably allowing the release of at least some identification, contacting and or otherwise customer related information that typically would not have been provided to the publisher or manufacturer of the branded item or service acquired customer.

In yet another embodiment of the present application, additional operability and value is provided. Soft drink and other beverage providers, for example, provide incentive information such as reward codes within the lids/caps of soft drink bottles. This is one example of branded product providers using added value, including in many cases the possibility of receiving a reward, within the packaging of their products. Many of these prior art programs require cumbersome and often unrealized secondary actions by the consumer in order to activate and/or receive the incentive or potential incentive. For example, the redemption code within the lid of a bottle of COCA-COLA typically requires the consumer to log on to an Internet site, or interact at the point-of-purchase or other external data source to determine information about their potential incentive.

The present application improves operability for cooperative marketing between brands, enhancing options for generated revenue for a plurality of co-op partners. Access to incentives is improved by eliminating a need for any follow-up actions by a consumer to receive incentive. This does not preclude configurations where the consumer may be requested to acknowledge information with a verbal or otherwise electronically provided command, however. One key configuration of the present invention requires no actions by the consumer beyond opening the packaging of a selected product.

In one embodiment, value is provided to several cooperative partners. A PDA device or other wireless and or electronic information receiving device, for example, includes additional operability to accomplish a physical task, such as a cellular telephone equipped with a bottle opener. In one example, such a feature may be a permanent configuration such a telephone, or may be a retractable, or otherwise extendable. A bottle opening feature, for example, of an electronic device to which it is coupled, such as a cell phone or PDA or other data managing device, may provide a data managing function related to linking the product and customer. This involves preferably a wireless exchange of data between the product itself and a customer owned device. This “hybrid” device, thus includes an electronic functionality and a physical task functionality, which may or may not involve the permanent physical alteration of an external, system related item—such as a bottle top that is opened by this hybrid device.

An identification aspect of the packaging of the purchased item to be opened, or otherwise accessed, such as the bottle top of a soft drink, at least embodies product data, and may be accessed by electronic transmission to and/or from/to customers multifunction electronic devices, or other interactive exchange between devices and product/packaging compatible with a customer-product data linking system and method.

This electronic hybrid device may include a cellular telephone, such as an IPOD or other PDA device, or may be an electronic car key or even a credit card (or other multipurpose, system linked item) that includes data managing operability and/or interactive data exchanging operability. In the present configuration an important distinction is provided over familiar interactive, consumer identifying means. Namely, the present application includes data exchanges between a purchased item and the customer's previously owned electronic device, by virtue of a physical change in at least one aspect of the item and/or the item packaging.

For example, an electronic car key with data receiving and conveying operability may include fixed and or retractable features such as a bottle opening device. When opening a bottle using the device, the bottle's packaging, which embodies at least product identification information therewithin preferably in the form of an electronic storage component, is altered and the electronic device triggers temporary accessibility of the product information to be collected. By opening the bottle top with the system compatible electronic car key, fixed components of the bottle top are stretched, broken or otherwise altered and function as a switch. This switch activates a transmission by the bottle top and/or the switch, and the data are accessed by external transmissions.

In one embodiment, any direction the bottle top is bent to be open by the bottle opener may stretch or otherwise alter fine wires (or other component(s)) embodied within the underside of the bottle top, which affect transmission and/or availability of electronic information held within a small data storage component within the soft drink bottle top. Information available from units embedded therein, similar to those injected into pets, may have a blocking feature that is disarmed by the alteration of the product/packaging, thus making the data temporarily or permanently available. Moreover, an actual transmission powered by a small charge provided within the product/packaging, the bottle top in this case, may allow for a brief, short range transmission of at least product identifier data, which may be received by the customer's device, which is in range of the transmission of the bottle.

In one configuration, an IPHONE bottle opener is used to bend and open the lid of a COCA-COLA bottle. In using the bottle top opening feature of the IPHONE, the device/IPHONE is enabled automatically, or by separate command (such as opening an application) to receive information either as a direct transmission or as data provided as a reflected transmission and extracted from an electronic transmission from the IPHONE. To preclude subsequent reception of such data, the physical change of the bottle top triggers a preferably temporary accessibility of data, for two seconds for example. Though not essential, a limited time period of accessible data occur is preferred to limit subsequent reception of that item's data by other devices.

Thus, in addition to altering the product such as the bottle top, the action opening the bottle acts as a trigger, making the information available, which was not transmitted and or accessible to external devices in the prior art. In this way, like the physical scratching of a surface on a sweepstakes card to reveal information related to and incentive underneath, the opening of a product with at compatible system component activates availability of system compatible information to be exchanged.

Further, the preferred configuration of the present system involves accessing information embodied within a purchased product by imposing a physical alteration to the packaging, which preferably cannot be reversed and/or returned to its original state. Automobile keys familiar to MERCEDES and other brands, which include at least one electronic component for maintaining and or transmitting identification information, might also include a fixed or retractable bottle opening aspect as the hybrid, secondary function of the device. Alternatively, the same automobile key might contain retractable letter opening device, which when use to release the sealed flap of a letter or other packaging, breaks or otherwise changes threads or other embedded elements that are configured to trigger data exchange between the purchased product and the electronic operability of the car key.

In yet another embodiment, by altering a product's packaging, such as by using an aspect of the customer's own device, a visual and/or otherwise scannable feature is revealed. For example, by opening the bottle of COCA-COLA using the bottle opening retractable aspect of a customer's PDA device, a barcode is revealed on the underside of the bottle top. The PDA device or other system components includes operability to scan or otherwise recognize this barcode is a system and method relevant identifier. Information related to this barcode, or other visual information revealed, may be retained as information within the customer's device, and may be communicated to another system component such as a compatible data managing device housed at a point of purchase. The product information obtained by the customers device may be electronically transmitted to an external data managing device, such as a hub computer managing multiple aspects of the cooperative program and/or a hub computer at COCA-COLA, or other cross-marketing partner computer configured to receive such product information from such customers as an aspect of overall system operability. These interactive information exchanges are also relevant to configurations of the system and method based on other product information gathering options, such as the wireless information exchange between product and customer device previously disclosed, herein.

Another embodiment includes the option of replacing wireless data exchange between product/product packaging and customer owned devices with an electronic exchange between a customer device and product packaging that is instigated and/or occurring once the device is purposely put into physical contact with the packaging. In yet another configuration, the exchange of information between the customer's device and product packaging does not involve physically altering the packaging, and exchange of information between these two components of the system and method occurring based on a variable relevant to at least one of those components, such as proximity of product packaging and customer device to each other and/or at least one other system component, such as a component maintained at the point of purchase.

In relation to the functionality of the present application, a myriad of equivalent product identifying purposes become evident. For example, in lieu of scratching and obscuring aspect of a sweepstakes card to reveal incentive relevant information, such as a number or barcode, by a customer linked device reads and/or exchanges data with such a sweepstakes card or other object embodying sweepstakes relevant information. In a simple configuration, customers' cellular telephones or other electronic devices may include visual scanning mechanisms, to recognize information revealed on a sweepstakes card, for example, thereby allowing for options such as a relatively immediate confirmation of sweepstakes winnings or other incentive results, through wireless or other electronic connectivity between the customer's electronic device and at least one other system relevant data managing system.

Further, the disclosed innovation of customer electronic device functions as a hybrid configuration, allowing for secondary functionality, and may be designed to allow for ancillary cross marketing benefits. For example, a lottery sweepstakes may be configured in a cross marketing scenario with at least one product provider. For example, the COCA-COLA scenario described above may involve direct or linked information relevant to a separate incentive program, such as a lottery. Instead of purchasing a lottery ticket, the benefit of receiving a consumable product or other additional benefit through linking lottery information with a cross marketing provider, additional incentive for customers to participate in the lottery are provided. Through physical alteration of the product packaging, selectively involving a customer's own device, point-of-purchase or other electronic system component, the opening of the product at least instigates the revealing and/or exchanging of lottery relevant information.

Further, layers of cross-marketing benefits may be provided, including the ability for the lottery and or the product provider to derive benefit from the tandem sale, including but not limited to new operability to exchange and/or receive agreed information relevant to a customer. Continuing with the above example, by receiving the “COCA-COLA” embodying information related to a lottery sweepstakes, the customer may agree, by simply opening the bottle with an aspect of his system linked electronic device, to receive subsequent lottery solicitations, which allows for the future participation in lottery options through only his electronic device and without the need for future COCA-COLA purchases. This becomes feasible and valuable as information identifying and/or further relating to the customer becomes potentially available to data managing component(s) of the present application. The customer may agree to information exchange by a simple act, such as receiving and/or opening and or otherwise interacting with the information embodying product.

In an example scenario, a customer's FORD motor car has a car key that includes a retractable bottle opening aspect. FORD, COCA-COLA and SONY PICTURES agree to participate in a marketing program, facilitated by operability of the present application. In this program, a customer purchasing a selected bottle or bottles requirement of COCA-COLA products, may receive free tickets to gain access at a theater to see a new SONY picture. This redemption may occur through Internet linking wherein the customer agreeably receives information, subsequent to the purchase of the COCA-COLA products, which may be printed or otherwise involved in redeeming the movie tickets.

Such a redemption may also be facilitated simply by information relayed to the theater, identifying the customer by recognizing his electronic device or by another authentication options. A distinction between simple exchanges of incentive information herein is demonstrated by one important configuration of the innovation: COCA-COLA bottle tops, opened by the customer car key device have been currently altered and, in the process, an exchange of data specific to those bottle tops and that electronic quirky device occurs. This links the customer with that one, specific item/bottle, and its related incentives and/or subsequent communications and options. The electronic key opens and starts an automobile and it further opens the top of soft drink bottles and other bottles. Moreover, information is received from an aspect of the bottle(s) that is wirelessly transmitted and/or conveyed electronically when in contact with another device, such as the automobile when the key is in place to start the car. This key may perform a multitude of electronic and/or physical tasks, depending on the respective embodiment including all or some of the co-op partners. Through wireless connectivity, the car key may further exchange information with at least the product and the automobile in interactive exchanges.

These transmissions involve external devices also selectively linked into a marketing cooperative involving at least one external hub that are computer operable to receive and manage information relevant to a plurality of customers. For example, customers that would otherwise have no relation to each other, beyond the consumer choices, lead to possession and/or use of system components related to a system recognized purchase.

In still further configurations of cooperative programs facilitated by the present application, a transaction involving a customer by an electronic device embodying and/or equipped to access information relevant to that customer, may allow for still further exchanges of information relevant to an incentive and/or exchange valued by the customer and/or at least one other cooperative program partner. For example, a customer purchasing a FORD car may receive, related to other purchases (such as the COCA COLA), 20 free tickets to SONY PICTURES releases. At the theater, redeeming his tickets may be as simple as walking through or in proximity to a device capable of receiving wirelessly exchanged information from electronic car keys or other electronic device linked to the FORD car purchase. Such an exchange of information in redeeming the movie ticket(s) may include and/or allow a release of customer relevant information to SONY, for more other relevant cross marketing partners, as a term of the movie tickets incentive.

In one example embodiment, the FORD car key may insert into a COCA-COLA dispensing machine, for example at the movie theater that, when turned, provide a free or advantage transaction such as a bottle of COCA-COLA. The key may identify information at the customer's option or automatically at a concession stand, thereby triggering an incentive such as a 50% discount of the customer's purchase of popcorn when a point-of-purchase electronic system component recognizes the customer by way of information provided/transmitted by the customer. In this case, the customer is identified as a member of the FORD-SONY co-operative program. As a member of this co-op program, additional system value may occur and be facilitated, including an agreeable release of information by and about the customer to selected providers of products and services relevant to the program. For example, SONY may be entitled to receive information about the movie choices made by the redeeming customer. Further, ancillary products such as COCA-COLA, may receive information such as the customer's e-mail address, agreeably provided by the customer as an aspect of the redemption, with this exchange of information being instigated as an advantaged purchase of COCA-COLA at the concession stand.

In yet another example embodiment, the potential of small electronic components providing powerful customer incentives is demonstrated. Though any customer linked device is relevant, the present example will again be described relative to a FORD car key that includes both data managing components and/or data exchanging operability within its housing. On purchasing certain products and participating in selected transactions, information may be provided to this car key while in connection with the automobile physically and/or wirelessly. Herein, the exchange of information is instigated by physically altering another component of the system, in this example again the example of the bottle top will be used. Once twelve COCA-COLA bottle tops have been opened using a bottle opening component of the FORD Car key, a structured cooperative program provides a designated incentive to the customer.

As with other electronic components capable of downloading content or other information wirelessly, the present example demonstrates a fulfilled customer action. In this case, the purchase of twelve COCA-COLA products allows for identification of that customer as an approved recipient of a designated incentive. To demonstrate enhanced operability of incentives relative to such devices, the reward incentive for this customer is at least one downloadable piece of media, such as a motion picture. In this instance, again the media cooperative partner is SONY PICTURES. Once the car key has provided information relative to the product purchases, which were received and stored as data within this car key, this information may be exchanged with an external computer linked to and operable with the incentive program.

Continuing with this example, by starting the car by inserting a key into a socket (or even by the key allowing for car operation by virtue of its wireless proximity to a wireless data receiving aspect of the automobile), information relative to the product purchases is confirmed by the use of the key in opening products. Information embedded within or transmitted by those products is conveyed to an information managing component within the automobile. The automobile and/or the key may then have system interactive operability to confirm the completion of the incentive customer obligation, triggering a transmission of data, which itself may be all or part of the incentive. In the instance that it is all or part of the incentive, the incentive may be one or more SONY MOTION PICTURES typically available on DVDs, being received by the automobile and/or the key wirelessly. Such content may, for example, be viewable on screens within the car, once downloaded. Further, such content may be received by and/or conveyed to the car key and or other linked electronic device, to allow the content to be viewed in locations other than in the automobile. For example, the car key may include and/or embody a computer connector, such as a USB device. When the key is inserted into the customer's computer, not only is the incentive media agreeably provided to the computer, directly from the key or by separate download authorized by information provided by the key, but a wide range of additional interactive possibilities and information exchanges may be accessed and/or triggered, whether agreeably received by the customer or not.

In this way, layers of cross marketing value two distinct entities, such as providers of goods and services, are many and are limited only by the configuration of the cooperative and his partners. In one example, the only definite cooperative partner is FORD, as the provider of the customer's electronic device. If that device were an IPHONE, for example, the co-op partner would be Apple. Moreover, the primary provider of the cooperative, such as the entity operating the hub computer of a cooperative, does not have to be the provider of the customer's electronic device, though may be.

The teachings herein allow for an exchange of information in a preferred configuration, including exchange that is instigated by a hybrid feature of the customer's electronic device being used to alter the packaging of a product that is linked to a selected cooperative program. This may be a permanent alteration. This alteration in the packaging preferably causes accesses to embedded information and/or triggers a transmission of information from an electronic component incorporated within the packaging of the product. The customer's device includes operability to at least access and/or receive this product information triggered by the physical alteration of that product, preferably though not necessarily by the hybrid feature of the customer's device.

This transaction information may be wirelessly transmitted by a customer's device, at the point of purchase or elsewhere, providing at least purchase information to an external computer that is at least linked to aspects of this co-op program. Customer information may be exchanged within the co-op program interactivity, as may be actual content related to the incentive for the customer. This customer incentive may also be confirmed by the system at least in part from information conveyed by the customer's electronic device related to the product purchase. Point of purchase computing and/or Wi-Fi capability may be involved and included as component(s) of the present application in relaying and/or exchanging information with at least the customer device and/or product item purchased. Customer incentive(s) may be then relayed to the customer electronically, and or electronically accessed by the customer subsequently. This access may involve the physical use or presence of the customer's electronic device used when purchasing the product initially, or other device linked to information related to that purchase.

Operability for enhanced purchasing and information gathering options for consumers and/or product manufacturers and retailers may be provided by way of customer PDA devices (or other electronic, interactive portable devices, linked into the product recognition system and method herein. For example, the customer's PDA device may be employed at a point of purchase to visually recognize a product, by a visual scanning feature of the PDA device (such as a “camera” or “scanner”). In recognizing a product by its feature(s) and/or bar code and/or other identifier, including the transmissive/reflective signals described above, linked data management components allow for enhanced options. These may include matching customer information (such as profile and/or contact information and/or past purchasing pattern data) with information related to a product identified by the PDA. Customer dietary restrictions and/or parameters, defined by the customer or other source, may be compared with data related to an identified product maintained within a remote data managing computer, maintained at the POP and/or by a product maker or other system/method linked source. In such as scenario, a simple example of the network operability might include a customer scanning JIFFY PEANUT butter, by pointing her PDA device at the packaging, which is identified by certain features which may or may not include a bar code or wireless data exchange between product and PDA device. The PDA device then provides/accesses through its own connectivity and/or by way of POP wireless interface and data management operability, data related to the customer and the product, replying with a message that “PEANUT BUTTER IS NOT ALLOWED WITHIN THE CUSTOMER'S DIETARY RESTRICTIONS.” Further, a secondary product recommendation may be made by the system and method parameters, under a certain configuration, to suggest alternate product(s) in lieu of peanut butter, with those ranked (for example) based on the customer preference priorities, of calories per service and secondarily, price per measurable unit (such as an “ounce.”)

Further, customer curiosity in the product may allow POP operability and/or the product maker's linked computer(s) to convey current coupons, discounts, information, or other customer-specific options facilitated by her demonstrated interest in that product. Further, unrequested information may be made available to the customer's PDA device as she walks the aisles, by way of product proximity determined by the PDA device from the products identified and/or the POP determining by location tracking means of that PDA device relative to certain products.

Further, paying product makers and/or other criteria, such as customer relevance and potential interest, determined by the store/product based system, may provide influenced information that is designed not only to inform and/or generate advertisement revenue for the store, but also to be of a determined “acceptability” and “relevance” to the customer. For example, of “five” solicitations sent to her PDA device, three were less lucrative to the POP in conveying to that customer. Thus, as the system determined greater value in that the customer may believe, care, or accept, the information and potentially conversion to a sale by way of quality and targeted relevance as determined by programming of the present system/method, most likely maintained by the multi-product seller, in this case at the point-of-purchase.

Information related to products may be accessed immediately, and information may be presented in a customized way to a customer, based on correlation of product information and customer information within the PDA device or external computer(s) related to that customer linked to that PDA device's operability. Further, incentives may be correlated and provided uniquely to each customer and may even be triggered by relevance of products to that customer, as customers are in a close proximity to the products as they move through the store isles. Further, issues such as “NO STORE HAS THIS LOW A PRICE ON BRECK HAIR SPRAY TODAY” or “NO OTHER STORE WITHIN 35 MILES CARRIES NORDIC NATURALS VITAMINS,” allow for discreet factors to be weighed in conveying information to the customer's device, whether with the customers' approvals or not. Relevance to the customer based on profile and/or past purchases and/or other data may be factored in conjunction with other priorities occurring as system relevant data, such as what the POP is being paid by NORDIC NATURALS to provide information to that targeted viewer, who may meet discreet marketing criteria for that single brand, as conveyed by that brand to the POP data managing system. A determination may even have been made that availability of a vitamin would have more interest to that customer than what the next solicited customer received as information on that brand, which was “DID YOU KNOW NORDIC NATURALS VITAMIN 3 IS 20% CHEAPER HERE THAN AT ANY OTHER STORE IN YOUR TOWN?”

Further, coupons may be replaced by coupon data, which may, for example, involve a customer purchasing a product that has occurred as data on their PDA Device (by request or not) with a promoted advantage, such as discounted price or other “added value” incentive. Such coupon data (e.g., an “e-coupon”) might require a command or action by the customer to confirm a potential incentive; simply checking out with the item may be sufficient to confirm the offered or requested incentive.

Further, the maker of an item may have an arrangement at the POP, allowing for subsequent purchases. For example, buying a tin of TWINING tea, might result in an electronic message to the customer, before and/or after check-out, offering of home delivery of TWINING TEA at an advantaged price, monthly, if confirmed on the PDA device. Further, coupons may have time sensitivity aspects built in, such as “one hour to confirm this price at the low price with the free six pack of PEPSI included.” Further, as PDA device data may include contact and address information, added value elements may be transmitted as data redeemed at other vendors/sources with computing operability. Such added value may even allow for home deliver of incentives, after the point-of-purchase.

Accordingly, the purchases are likely with the customer approval or incentivized permission and linked to data that provide advantages in marketing objectives and monetizing potential at the POP and/or product makers, and/or co-op partners. Further, buying items for another is facilitated herein, with the customer (through a PDA application, for example) tapping a contact name, for a product or opportunity to be shipped and other otherwise communicated to that contact, based on a customer's electronic request. So, rather than remembering to tell a friend about a product, it is emailed directly to them as a function of the PDA device product recognition and/or solicitation and/or shipped to them as a product purchased for remote delivery, or for that customer to pick up during their next shopping at no charge to that friend, as the original shopper paid for it electronically as a gift to be picked up by that identified contact, etc.).

With regard to the aforementioned alteration of product and/or packaging to trigger product recognition exchange of data with customer PDA device, the present application provides a new option for POP “check out” that adds value while saving costs. Using a clothing store as an example, tags attached to clothing may include product recognition, including whether visual or transmitted (or reflected) or other product to device ID approach. Herein, “clipping” the tag, for example, may sever wires or other component(s) allowing for triggering of an exchange of data embodied with the tag and/or product. Thus, the purchase of an item may involve using a “tag remover” aspect of the PDA (in a hybrid configuration) device and/or may involve the PDA device being in a proximity or otherwise situated relative to the tag/product, to register that product and its price. For example, all of this may occur from a device within the tag, even a reusable device option may be configured, with the item identifier being left at the POP once the sale is registered and approved by the customer. Alternatively, one use of the item ID, within the severed tag for example, may occur.

For example, a customer removes tags from three shirts and a pair of jeans, which results in these items being automatically (with or without separate user command) billed to their credit card, phone bill, PAY PAL, designated store or credit card, or other preset, or other suitable payment option. Thus, no “check out people” are required, as simply bagging the items after clipping tags, results in approved charges and the ability to remove these items from the store as “paid for by that customer.” Alteration or PDA device rendering the item/tag otherwise used makes separate store scanning equipment and personnel unnecessary. Further, wireless store operability and data managing component(s) linked to the system of the present application, may interface with the customer's PDA device, to confirm or otherwise register and/or facilitate the transaction(s). Further, the customer may be further contacted or otherwise offered “special” scenarios for transactions, by way of released data from or accessed by the PDA device and or information conveyed by the device in purchasing the items, whether a POP and/or firm(s) related to the maker of the item(s).

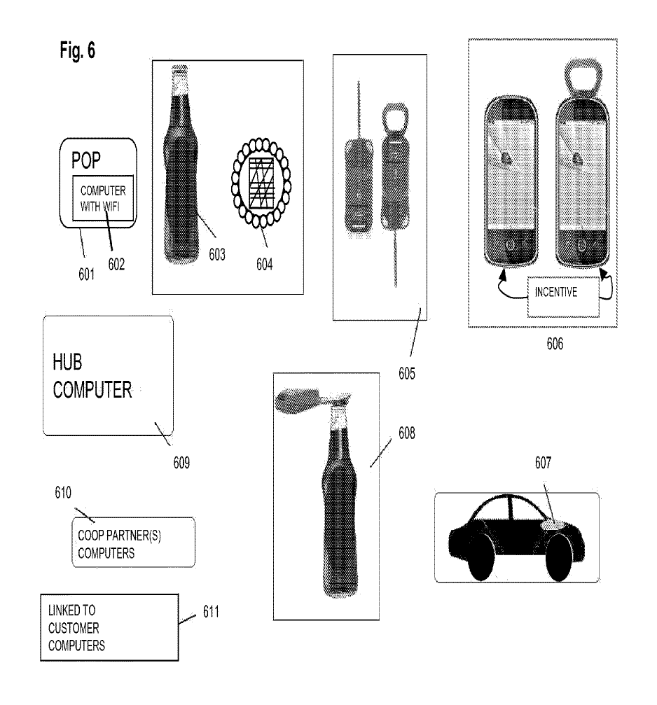

The following discussion with reference to FIG. 6 demonstrates a non-limiting example of one embodiment of the teachings herein. A customer enters a point-of purchase (“POP,”) in this case a “SEVEN-ELEVEN store.” The customer sees that Joe's cola 603, has a special added value program compatible with FORD. Using his FORD electronic car key 605, to open the bottles he purchases (a bottle opening feature is built into his key) triggers a small data transmitter to transmit for one second only 604. This data identifies each bottle of Joe's cola, each bottle having a unique identifying data sequence. After opening six bottles, the car key may provide a special incentive at the POP 601, and a determination is made that products purchased by that customer that provide the incentive and making those six bottles no longer able to be “redeemed” electronically.

To receive the incentive, the customer's email address from FORD is agreeably released to the hub information processor 101, in this case maintained by the maker of Joe's cola. This conglomerate also owns a movie studio. The confirmed incentive agreeably provides the customer's car computer 607, with a new motion picture to a media storage aspect in the car, for the children to watch on car monitor(s), providing the cross-marketing partner of Joe's Cola, (Joe's Pictures), with the customer information to convey the incentive media product. Further, the key 605 has operability to download the movie data, to be conveyed later wirelessly and/or by insertion of the key into a compatible socket of the customer's home data system 611. In this way, the customer may view the incentive movie on his computer and/or plasma monitor, linked to that computer 611, which now has accessed the media data from key 605.

As Joe's Cola also has a cross marketing program with IPHONE and AT&T, those devices 606, used to open the bottles 603, provide incentive(s) registered on the device 606, and redeemable as well. If the bottle top is opened/bent, by the bottle opening feature of the IPHONE 606, an incentive is triggered as the lid is permanently altered. This triggers a transmission from the data transmitting aspect of the lid 604. This can also be configured as a data reflecting aspect of the lid, by another cell phone featured that once accessed, “scans” data from such lids, (as with pet ID chips). Further, simple “unscrewing” of the lid, by units other than the IPHONE with bottle opener, provides another incentive, though a less valuable one as that primary device partner of the system/method, IPHONE provides when the actual hybrid phone with opener is used.

Continuing with this example, on attending a new film release of a Joe's Pictures movie, at a theater, the IPHONE customer gains discounted access once the IPHONE is recognized automatically at the box office. Further, a free Joe's Cola is dispensed at the concession stand to this IPHONE customer, as that earlier Cola purchase at SEVEN-ELEVEN is recognized by system operability once the IPHONE is recognized by the concession, POP, system-linked computer. In this instance, once the customer presses a “REDEMPTION” command on the phone, to not confuse the redemption with any other customers in line.

Further, the concession purchase choices by that customer as well as the choice of movies that customer has made, are sent to the conglomerate that owns Joe's Cola, and hub information processor 101 is relayed on as data to it's many marketing partners, by way of the customer identity information linked to that customer's IPHONE and/or related accounts of the system. Later, based on the movie choice the customer made, data conveyed between companies results in a solicitation for a beauty product featuring the star of the movie seen, as the spokesperson. This comes electronically to the customer's IPHONE, home computer and in later mailed materials, which physically arrived. When she bought that beauty item at MACY's, the e-coupon purchase advantage of half-off occurred automatically, as the MACY's Wi-Fi system recognized the customer and their relationship to the incentive, again by way of that customer's PDA device transmissions.

A further example configuration presenting additional functions of the present invention allow for any and all consumable products and/or non-consumable products, to provide at least identification information when these products and/or their packaging are altered relative to the state they are provided to consumer(s) in from the providers and/or manufacturers. For example, a standard cup, such as a soda cup used by convenience stores, may be made system relevant by integrating product identification feature(s). Such a soda cup may feature an aspect, such as a membrane, which is penetrated and altered by inserting a straw, which triggers a transmission of product information contained within that cup.

Such information may be directly received by point-of-purchase computing components, including wireless receiver(s). This information may also be at least receivable and/or linked to information specific to the purchasing consumer. Such linking would logically include correlations between consumer established databases, that are accessed by way of devices including options such as credit card(s), PDA and/or cellular devices, and/or consumer provided information that is provided verbally or otherwise entered by the user.

In a display network configuration, involving network components that may include consumable goods, for example, the confirmed use of such goods may trigger a related transmission to system computing operability that provides additional display network related services to the consumer. For example, a display network configured for social networking functions, as shown and described herein, may allow the confirmed alteration of a network acknowledged product to offer and/or otherwise provide at least communications options to a consumer. These may include those steered or at least affected by at least one advertiser's priorities, including those of the brand advertiser of the good(s) involved in the triggering of system relevant alteration.

Information searching options, including product searches, transactions and even incentives may become available and/or displayed in response to information exchanges occurring relevant to at least one display of a network. For example, the opening of a related product, such as the above-identified example of a bottle of COKE, may involve a proximity parameter relative to the display and/or the display's component(s) relative to the product and/or consumer and/or consumer transmitting or reflective device, for such options and/or incentives to become available.

Further, the teachings herein are not meant to limit operability to proximity to a component(s) in an out-of-home display network. Home computers and other computing and/or display devices may also be aspects of such a system, such as to convey at least triggered and system relevant product information. For example, opening the system component product, such as the bottle of COKE being the non-limiting example, may provide wireless components with information that a home computer and/or PDA, cellular or other consumer operated, may at least convey to an external computing component, such as a hub information processor 101. By doing so, social network, incentive, transacting and/or other consumer valued aspects/services may be accessed and/or provided.

For example, a consumer opens a COKE bottle, and his wireless system conveys the product transmitted (and/or reflected) data to his computer and/or an external computer. This may be accompanied by the consumer and/or product user's own information and/or related information. Thus, opening the COKE may allow for the consumer's AMAZON account to be affected favorably by the product related transmission, with a credit and/or incentive. Further exemplary of options provided by this operability includes a computer user, who accesses the product, in this case the bottle of COKE, may be upgraded or otherwise provided with a consumer valued aspect, within a social networking forum or other interactive venue.

For example, the consumer may be included and/or featured to others, where without the product information, the access and/or feature would not have occurred. Forums affected by advertiser priorities, and or paid venue priorities, may solicit, include or otherwise affect (or be affected by) the consumer who opened the related product. This may mean, a chat room of COKE consumers may be the group from which a single participant, and confirmed consumer of the product, may be elevated to become a guest judge on AMERICAN IDOL. Thus, the use of the product may result in an opportunity and feature involving the consumer's visual being provided to other viewers, including those watching on linked venues such as cable television, all as a result of the co-op partnerships of the venue and/or related advertiser(s).

Further, a public display such as a large stadium display/monitor is, in one embodiment, operable to function in tandem with system component(s) for electronically locating a viewer based on at least the physical triggering of system functions by affecting at least system linked product component. This triggering may or may not be conveyed via at least on PDA device related to the viewer, who in this case is also the product “user.” For example, the user punctures a seal on a disposable soda, which instigates an electronic signal or other trigger for system components to pinpoint an aspect of the user's physical location in a stadium. The incentive(s) provide to this user may feature an experiential media incentive, such that the user is featured for others to see within the stadium, if not also by way of other linked media system(s).

In one configuration, local Wi-Fi or other system linked signal receiving operability, informs at least positional data relative to that user, once the signal providing/reflecting operability of the system linked product, the soda, is triggered to fulfill it's electronic information exchanging function. Thus, an image capture aspect of the system, such as a camera component, may move and/or “zoom in” to the selected user among the thousands in the stadium for an anticipated or unsuspecting capture and display of content featuring the user and featuring the user interacting with the product/component, in this case the user-affected, disposable soda packaging.

In the COKE bottle example, twisting off the bottle top may provide the consumable product/packaging alteration linked to that item and releasing the system triggering information directly or indirectly as transmitted or reflected information to a locally situated and/or linked signal receiving and data processing operability related to providing incentive media.

Further, the alteration of a product and/or its packaging may provide access to a sweepstakes, a lottery, or other valued service often associated with confirmed direct or secondary purchase(s). Furthermore, media access to movies, music, live events and/or other information provided to the consumer by way of the computing device the user is using, or other designated or associated device(s) is provided herein. An example may include the opening of a DVD package that triggers an information exchange, allowing for other media to be accessed and/or provided by the consumer's computing device(s).

For example, the opening of a MIRAMAX DVD in the vicinity of a user's PDA device, with an agreeable release of at least some of the user's personal information, (such as name and cell and/or email information, and/or other information) may provide subsequent movie(s) to that user by download, streaming or other media delivering component. Further, that same user might instead be provided with access to selecting a project to become involved in, as a “home producer.” An example of such home producer is disclosed in U.S. patent application Ser. No. 11/517,114, entitled “SYSTEM AND METHOD FOR PROVIDING INCENTIVES IN EXCHANGE FOR RECEIVING PROJECT CONTRIBUTIONS, and filed on Sep. 6, 2006, which is incorporated by reference, herein. For example, buying twelve Miramax DVD's (as confirmed by opening and exchanging information receivable by a user's computing device) provides an interest in a project yet to be filmed, distributed or otherwise monetized and/or informed creatively and/or with regards to viability, by an audience.

Further, a consumer's use of a system relevant product, at home, or in relation to system linked component(s) elsewhere, may provide the opportunity for uniquely tailored content to be conveyed to that user. For example, the user's name, likeness, provided visual and/or audio content, or otherwise accessed and/or provided information, may be at least in part utilized by system functionality to create a unique media file transmitted and/or accessible to that user. In this example, the MIRAMAX DVD purchased by a user, JOHN SMITH, may result in his name and even content provided by or related to him, being integrated and/or referenced in the creation of a unique media file, such as a file derived from a rough-cut or completed (even previously distributed) motion picture, changed and/or affected and/or supplemented by information provided by, or related to, the user.

Thus, that user may be the first “producer” listed in the credits, uniquely on the version transmitted and/or accessible electronically by that user. And/or, that user's FACEBOOK account and/or directly submitted content, may provide the visuals used within the pages of a “yearbook” featured in a scene in the film, allowing that user's related media to be directly integrated into the media file content, whether as type within the credits, and/or within the “live action” media portions of the file.

Further, that user may be empowered to inform and/or create customized versions of the film, perhaps selecting from available scenes and/or endings, and/or actors, to assemble optional segments into a user-determined version of a film. This may even inform a project related to other distribution options, sampling the most popular “version(s)” of a project, as directly informed by users/consumers. User related information and/or content may even affect portions of content, such as a character occurring with the likeness, voice or other aspect, of the user, as affected by content modifying operability and programming, designed to alter portions of aspects of live action segments within such a subsequently provided media file (related to incentives and/or aspects valued by a user/consumer, which may be triggered by use of a consumable, network liked product).

Again, such media incentives may be as simple as a consumer specific piece of content being provided and/or captured, and displayed on at least one computing device screen and/or out-of-home display. These displays may be direct view, projected, or other image manifesting display(s). As described above, a bus kiosk display, linked to the network/system, may allow for “photo-booth” display of the product user, when that product and/or other device informs component(s) of the display system, by transmission for example, to provide the photo-booth incentive.

When the consumer and his girlfriend, for example, are captured and shown on the display, an incentive of an option to have that, or another image, printed and/or transmitted may be provided, for example. The consumer may agree to release contact information, such as an email address and/or cell number, or other information, and providing system and/or advertiser valued information for linking, tracking and/or contacting the user, and/or otherwise factoring that user relative to the use of the related product and/or related products/services. Even direct charge for convening the photo to a cell phone or email account, may allow for revenue to be generated from providing customized content to consumers and/or display network viewer(s). For example, a cell phone account, or other consumer linked account, may be billed to receive the image(s) captured by aspect(s) of the display(s). Further, social networking functionality may allow such information to be exchanged between other viewers/consumers, or other's linked through other media networking means to the display system.

Thus, searching for partners and/or being paired with others, for interaction or other cooperative purpose, may be provided in accordance with the teachings herein. Further, the related use of a product(s) may provide specific access and/or value, based on that use and/or other interactive exchange(s). For example, a person opening a bottle of COKE in a bus kiosk in New York City may engage in a dialogue arranged by the system with another confirmed COKE drinker in London. This dialogue may be valued by the brand and/or system beyond incentivizing the use of the product, for example, by allowing the featured two consumers, and/or others linked to the media, to provide system and/or brand valued information. Such information may be affected by the two consumers' dialogue, for example.

Further, the consumer(s) may be featured live on television, the web, or other venue, and/or other displays, as an aspect of the incentive or other valued operability of the system. In this way, content is created that has ancillary function and value, beyond simply incentivizing a person to use the product and receive a media, or other linked, incentive (such as a cash reward, prize, discount, or other). The opportunity for a consumer interaction via the network/system to lead to that consumer being, or affecting, other cooperatively linked brands' promotion also exists.

For example, a consumer of COKE may end up engaged in a discussion about a movie valued by COKE and/or the system and/or the consumer(s) as a result of the initial system trigger affected by the use of the COKE product. Even consumer interaction via the display or other linked computing device may lead to a confirmation product use coupled with additional provided and/or accessed information related to the consumer to affect subsequent interactive options. Thus, that consumer may agree to allow and/or provide system access to information, directly or by way of other database(s), which may result in a consumer of COKE being engaged in a system valued interaction with twenty other network participants, such as new MERCEDES cars. Thus, another brand, for example, may benefit from advertising and or information targeted viewers being delivered uniquely by way of system operability.

Further, consumers and/or users engaged via the system may themselves seek information and/or people, such as for information and/or interaction and be affectively “steered” to other areas and/or people, including other consumers who may be valued by the system and/or another advertiser. Even relevance of other information and/or interaction options may be weighed by system computing operability and programming to factor relevance and interest of options in selecting brands and/or information for subsequent display and/or prompting; relative to system users/participants, such as those accessing the system following a confirmed use of a system recognized product.

In this way, a ten minute wait for a bus may result in viewing a display and engaging a person, such as person having interacted with the display/system electronically (via a product, device or direct verbal/visual interaction). During this event, COKE may be promoted to those affecting or those affected by the display by use of that product. Further, the interacting person may search for information and/or other individuals, and/or be prompted and/or steered toward information during the ten minutes. As a result, that person may engage in dialogue and/or be provided information relative to other brands and/or people, allowing for a number of system priorities to have been achieved during just 10 minutes. These may include revenue generating opportunities from advertising, data gathering, generating valued media featuring such interactive participants, transacting among other possible valued options.

Further and in relation to PDA devices functioning in tandem with a network, bar code or other visual scanning devices may be incorporated to function in tandem with the PDA device(s). These scanning device(s) may further be incorporated into the housing, as an aspect of, PDA device(s). For example, a PDA device linked at least by information to a user, may include a laser or other electronic signal and/or transmission that is received by the PDA device generating that signal/transmission and/or another component of the system coordinated for this purpose.

For example, an IPHONE may have a laser generating bar-code reader (such as in a grocery store scanner) generates from battery power or other power source an electronic and/or light transmission that is affected by an aspect of a user-targeted consumable product, for example. Affected transmission, read by the PDA or other linked device subsequently, provides information conveyable to the network as data, which may be linked to other information relating to the user. This option, which supplements the aspect and option of altering a product and/or the packaging of a product, involves at least simply linking user information with point-of-purchase information related to at least a product. One example application of this operability, is that purchases of items may occur without the need for personnel to “checkout” or confirm purchases, as credit/financial information from a user's PDA or linked database(s) may be accessed by the network, or linked network(s) in confirming the user's purchase or other relation to a selected product; typically a user selected product. In essence, “self purchase” of items in many environments may be facilitated.

Further, to include aspects of the “product altering” configuration, for additional functionality, the transmission or other affect involving the PDA device of a user, or other linked component, may visibly and/or invisibly provide the “alteration” to a product. For example, a transmission by a PDA device, which may relate to generating data for the system and which relates to a specific consumable item, may further change or alter that item and/or its packaging, specifically. Thus, a magazine with an item-specific ID, such as a barcode, may be altered by the user's affect on that item using a PDA device, for example, and/or by his own physical affect on that item.

Accordingly, in an embodiment, a transmission resulting in data may cause and/or function in tandem with a demagnetizing function of an aspect of that product, such as a plastic-wrapped magazine. After the user breaks the plastic surrounding, that package may be a factor linking that identified item with that user. Moreover, or alternatively, a user affecting a product with his device, or physically and/or otherwise, may not only create a linking of personal and product information relevant to the system, but may render a product “safe” to exit a store with, removing a security aspect or condition of the product, for example. Thus, a newsstand may include magazines that users may purchase by simply linking to themselves informationally using a PDA device and/or other network linked device such as at the point-of-purchase. Further, once linked to that user by the network, and/or once that product is altered electronically or otherwise, that user-linked item, such as an item “purchased” agreeably by a user, may be safely taken from the store or other place with electronic (or other) recognition that this item is related to the user uniquely now, for example, indicating that it is not a “stolen” item.

Additional configurations of such operability, are excitement generators and even possibly incorporated as incentives for purchase, information providing and/or other interactive involvement of users/consumers. These include, the present operability of “product alteration” being related to system linking of information related to a user with a consumable product (such as a bottle of soda) and/or individual purchasable item, (such as apparel) being further improved to add additional marketing stimuli. For example, a user purchasing a key chain might affect the key chain electronically, through a signal generated by a PDA or otherwise, resulting in that key chain's user related alteration involving the user being featured within the item and/or it's packaging.

For example, a user purchasing that keychain may provide a transmission to that item directly or via other system component(s) that results in the user's likeness being featured on the key chain. This may or may not be related to purchase of that item or other information exchanging purposes. That user may identify a photo from a database, such as within his PDA device or external database via website or other system accessible means, which becomes featured at least in part by the item and/or it's packaging. Thus, labels on bottles, tickets, covers of magazines, CD packaging and virtually any physical item, may embody an electronically alterable aspect whether through electronic operability local to the product and/or imposed from an external device(s). Thus, a photo-frame purchased via the system, might feature a photo selected and/or taken specifically around the time of purchase, by way of the user's information being exchanged and featured by the item/packaging.

Such content and/or information featuring something as simple as a typographical feature of the user's name or provided verbal information, may be featured by operability that is local to the item and/or imposed, such as by printing on the item. For example, a magazine purchased by a user might include a visually alterable aspect within the cover and/or packaging of the magazine, thereby allowing the purchaser to appear in the cover visual with “Julia Roberts,” for example. This, as an added value to the purchaser, may occur as an aspect of linking the user to that product informationally for external database use. For example, the user may purchase the product via a PDA device linked account, such as phone or credit card account, or the like.

For example, the purchase of a Teddy Bear may involve a PDA device and/or other system component exchanging data with the item, which allows the item to create audio to speak a child's name, as the user relevant custom content and/or data are featured. For example, a system application may allow for a name to be spoken or otherwise provided or accessed, in relation to the purchase or exchange of information in relation to the product. The alteration to product, in this example, the user's daughter's name, is then spoken by the bear, altering the programming of at least an information bearing component local to the bear to be unique to the user, buyer, or potential buyer. Indeed, the pleasure of experiencing the customized item, affected by system relevant exchange of information, increases a likelihood of purchase, or, at least adds interest and experience subsequent to purchase.

Such added value, including customized alteration of items as a result of user provided signals and/or data, takes the opened bottle data accessing example to a different level of interest. By allowing the change in the item unique to the user to provide content to be featured, visually, audibly or otherwise, within system and item designed parameters, user interest is enhanced.

In another example, a bottle of perfume is being purchased by a user/consumer. Using an application or other utilized system relevant option(s), the user selects a visual of his wife from his IPHONE. The IPHONE transmits the image to the item. In another embodiment, the point-of-purchase includes signal receiving component(s) for affecting product(s). In continuing with this example, the bottle of perfume includes a paper-thin, visually alterable surface, similar to a changeable video features of a KODAK custom photo frame, wherein electronic images may be altered in the frame image area, involving local battery power. In this example, a chip and/or other information managing component(s) on the underside of the bottle are operable to receive selected data and manifest that data, visually, on the alterable surface of the bottle. Thus, in this example, the user in purchasing the perfume has provided a system relevant information exchange that was also related to his AT&T/IPHONE account being charged for the perfume purchase, e.g., $100. Via his system-relevant application and option provided as added value, the purchaser selected his wife's image and imposed alteration to the item manifest in the system as a linking of user data and data related to that particular exact bottle of perfume. Further, by user selection of his wife's image from image data local to his PDA, the purchase was further acknowledged by at least part of that image data being featured on the bottle, in essence customizing that purchased item for the buyer.

In a less marketing based example, a magazine purchased by a user at an “automated news stand,” might involve the bar code of that issue of NEWSWEEK to literally alter, visually or at least with regards to information maintained within the magazine/packaging. Such a bar code alteration might involve a hybrid result, reflecting aspect(s) of information related to the magazine and the user. This, for example, might allow the issue to be taken from the point-of-purchase by the user, as subsequent scan, for example, might confirm the user linked alteration of the item by other system component(s). Thus, a user deciding to buy an issue of ARCHITECTURAL DIGEST, might select the item through a PDA application, a point-of-purchase provided option or by “scanning” the item with operability of his PDA device, (among other option possibilities). This user allowed linking of information results in a visible or other imposition to the item, which is maintained preferable local to the item and/or in a point-of-purchase and/or system operability database. Thus, this user-linked item, whether it has been customized by data such as content related to the user, is now “his” and may be taken without question about the relationship between the individual item and it's new owner.

It cannot be understated that with the system relevant information linking the user to an item that otherwise would have been purchased with no externally maintained data related to the user buying and/or providing information related to that product, at least one layer of additional value is created for at least the creator of the product, for example.

In yet another configuration with distinct operability:

The system operability for individuals in the vicinity of or more (at least) visible displays of the network(s) to provide stimuli that is converted to system readable data, which also informs at least the selection of visuals, displayed by one or more display(s) of the system/network. Such stimuli may be related to transmitted data, such as that linked to an individual by way of his PDA device, such as a cellular phone and/or other battery operated computing device.

The important operability in this additional exemplary configuration, improves on at least the important information gathering and managing functions of a system and/or method related to such a display network. The tandem weighing, by system computing and programming, of information provided (and/or related to) at least by content providers and content viewers of such a display network, allows for unrivaled targeting of content/advertising targeted viewers, (viewers) by a variety of parameters including actively or passively determined viewer demographic, viewing location, time, weather, viewer's relation to cross marketing partners including cellular providers and credit providers, among other discreet parameters.

The collection of targeted viewer information, whether provided separately or in tandem, may include transmitted and/or linked computer maintained data provided to computing of a component addressable display network. PDA devices and/or cellular devices, or other signal transmitting devices, including battery operated devices, may provide information to component(s) linked to the network. This information may provide or allow access to targeted viewer related information, such as traits, preferences, past behaviors, transactions, memberships or the like.

Further, such receiving components of a network may include components for actively profiling targeted viewers, such as cameras collecting visual information related to viewers and operability to collect fragrance and/or other sensory stimuli emitted by and/or related to at least one targeted viewer (or potential viewer) of a networked display. Such directly captured and/or collected sensory stimuli is subsequently converted to system operable data for analysis and may be selectively utilized in trafficking at least content to at least one display of the network.

Such sensory stimuli may be directly relate to physiological and/or biological aspects of a targeted viewer, including but not limited to emitted scent(s) sounds, visually sampled physical aspects (such as height, weight, facial details, or the like) and one or more forms of DNA, for example, provided agreeably to network components or otherwise accessed by the network directly and/or in relation to a target viewer, including from externally accessed database(s). DNA-related information of a targeted viewer may be accessed from previously sampled biological information that is stored in a database. Information may be provided by the user/viewer directly, by interacting with a system/network component designed to safely collect biological material that is measurable by the system. For example, the system may quickly analyze at least one aspect of such material, convert it to network relevant data, and use it to affect interactive information and/or advertising provided to that user/viewer.

Even the physical behaviors of targeted viewers, including pace of motion such as walking, eye motion including pupil motion and/or dilation and/or eye-time on at least one display of the network, may be sampled and relied on, at least in part, for electronically implemented decisions and/or information collection of the network.

Thus, targeted viewer biological, physical, physiological, mental and/or other body related aspects are collected with the reception of electronic signals related to the same viewer is provided. One configuration of the improvement(s) herein, includes at least a PDA device of a user, such as an IPHONE, being coupled with another personal electronic component. The other component is preferably distinct from and/or coupled with version(s) of familiar audio headsets typically manufactured to relay audio from PDA devices to the ears of users. This modified headset preferably includes brainwave sampling component(s), which are known in scientific instruments used to monitor brain activity through various types of brain wave emissions, as well as consumer games, some of which sample at least some such waves in allowing users to affect the motion of objects and aspects of visually displayed images among other computer implemented, user informed effects.

An example of such device(s) that sample brain waves involving biofeedback wherein an electronic system samples at least some brain activity electronically for use in affecting computer managed information that is subsequently displayed and/or provided in a visual and/or physical form for, for example, medical use, psychotherapy use and entertainment use. For example, current versions of such systems allow a sampled user to view his own brain waves, such as beta waves, that are represented on a video monitor for reference in affecting and/or “training” his brain to emit waves in a modified manner to control video displayed representations. Typically such training is linked to objectives determined by professionals, who are seeking medical improvements for patients using brain activity modifications involving, at least initially, intentional intervention of brain activity.

In the present application, a brain wavelength monitoring device is preferably coupled with the operability of an audio headset. The brain wave monitoring component(s) may also be coupled with a head mounted video display device, including 2D and 3D display devices that resemble oversized sunglasses, and also incorporate audio components. The preferred configuration incorporates the brain activity monitoring operability/component(s) within multi-function device(s). A distinct, head mounted or otherwise body-liked device, may measure or interact with at least user-emitted brainwaves (alone or in tandem with other body related measureable aspect(s)).

In a preferred configuration, a PDA device linked to, and/or designed to work specifically with body aspect(s) measuring components, may provide critical “passive” viewer response information to computing of the network, for example. Thus, at least brain activity as collected by components owned and/or used by a viewer, may directly or by way of a linked user PDA device, transmit user related information informed by physical aspect(s) of that user (including brain activity) to collection component(s) of the network.

For example, a network display 107 may provide advertising content at a given time. The initial visual may or may not be already determined based on other information related to at least a targeted viewer. That same targeted viewer may initially, or subsequently, provide information to the system by transmission (or electronically measured reflective signals or other electronic information collection means). The targeted viewer may provide information to such a network, for example in exchange for incentive(s). Such incentive(s) may be provided immediately, such as displaying that viewer's image or other viewer rewarding media, on the display, or may be provided subsequently as merchandise, information, discounts and/or other advantages related to the network and/or network linked partner(s).

In the preferred configuration a viewer agreeably participates in allowing the network to sample at least some body related information, such as brain wave activity. His IPHONE, for example, has an application to manage information at least collected by a linked component of the PDA and/or network, such as a brain wave measuring component(s) of his audio headset. The network may provide visual stimuli via a display 107 and/or viewing operability of his IPHONE (or other PDA device). The network may directly and/or via his IPHONE provide audio stimuli as well, potentially even “interrupting” music that viewer may be listening to, as part of the participation with network operability.

On seeing, hearing, or otherwise experiencing network generative stimuli, including stimuli such as fragrance the viewer may provide transmitted information related to his brain waves or other measurable body related aspects, including for example blood pressure, pulse rate, perspiration, temperature, etc. to at least a collection component of the network. This information may be all or part of the viewer related information that informs the network selection of content, such as visuals, for display to at least the viewer; directly by a networked-provided display and/or that viewer's IPHONE or other computing device.

As just one benefit of this operability, a provider of content, such as an advertiser, may enjoy the benefit of targeting viewer(s) 106 and/or being charged for advertising, based on viewers substantiated as quality targeted viewers by information including but not limited to their physiological/psychological reactions to at least the provided content. Further, the targeted viewer 106 may be substantiated, as least in part, as a desirable media targeted viewer of selected paid content, for example, based on the viewer's body aspect reaction to other media, such as “test” media designed to elicit ideal measurable reactions for subsequent network computing determination of best “paid content” options to provide to that viewer.

Further, such collected body-related information may inform interest level and/or relevance to a particular viewer, allowing the network computing operability to weigh not only revenue potential of information gathered from and/or content provided to a viewer, but to also weigh the critical factor of which content or networked-provided stimuli options may affect the viewer's viewing and/or interactive interest level and potential to maintain a longer amount of time interacting in some way(s) with operability of the network. This may involve interacting in part directly with networked-provided content display(s) 107 and/or subsequently provided information sent to that viewer's IPHONE and/or other computing devices, such as home computer(s).

Thus, even games related to viewer(s) interacting with network stimuli, including visuals provided on display(s) 107 (publicly situated or otherwise) may allow incentivized interactivity to open new avenues of viewer interactivity with other viewer(s) in remote locations for example, while providing enormously expanded operability to advertisers. For example, games may include ways to determine discreet brain wave and/or biological reactions to networked-provided information, thereby allowing for new levels of viewer targeting based on passively provided personal information that may be solicited directly by networked-provided information.

Thus, accuracy and truth, for example, may be determined in relation to a viewer by passive means, whereby the viewer or user may provide information in ways not consciously determined by the viewer or user. For example, “do you like this car” posed as an audio question over a user's IPHONE, may trigger the user to view a new model of MERCEDES provided on a public display of a network, (such as an electronic billboard) and/or on the user's IPHONE display. The user's reaction is collected from brain wave changes relayed from the headset components to his IPHONE, conveyed to network components as usable data filtered by the IPHONE application.

Such viewer transmitted information may be supplemented by verbal response, visual response, a touch of an option provided on a display and/or on his IPHONE/PDA, or other consciously provided interactive response. Even the interplay between conscious and passive information collection may inform at least hub information processor 101 about the viewer, and possibly also the advertiser who may be linked to the provided content. Such information may inform selection of subsequent content to present, and where to “steer” the viewer with regard to social network interactivity and/or advertising, which ultimately may result in monetizable value.

For example, CALVIN KLEIN may want to know if a new dress will sell. The display of his advertisement may or may not be a paid service alone. However, the tandem or distinct paid service provided by the hub information processor 101, for example, is that aspects of viewers' 106 eyes, including pupil size and the amount of time the viewers 106 view the CALVIN content are measured after network camera(s) collect visuals. In this example, the slowing of body activity may also be measured, as well as biological aspects of the viewer that his IPHONE linked components collect, such as his temperature and pulse rate. Further, shifts in brain wave activity occurring during observation of the CALVIN content provide discreet information about that viewer's reaction to the content, in this case relating to a new product. When asked a subsequent question about the product, even if it is attractive or of purchasing interest, not only may conscious interactive response(s) further inform the interactive session with the viewer, but even potential truth of the conscious information may be measured, for example, as a function of collected data.

Further, such passive information may inform network operability, including computer driven decisions, to involve and/or solicit a viewer into interactive dialogue with other interactive participant(s) be they other viewer(s) of displays of the network, home computer users, or PDA users, etc.

Thus, herein, an interactive display network is enhanced as at least a media targeting tool, and information gathering system, relative to at least paid advertising and/or data gathering objectives of partner(s) of such a network. Further, operability of the present application herein may pertain specifically to users of various devices, such as just their PDA devices, and/or just their home computers. Moreover, the involvement of an out-of-home addressable display network is provided that enables a user interaction via visuals and/or other stimuli provided by non-display network components, such as just information provided as stimuli over a PDA or other device, may allow for the exchange of the passive and consciously provided information relevant to at least the network, and likely at least one paying advertiser and/or partner of such a network. In other embodiments, networked displays 106 may not be provided.

Thus, various options and improvements are provided by the present application in connection with at least advertising, out-of-home and social networking venues and industries.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A method, comprising:
a) storing, on one or more processor readable media that are operatively coupled to one or more processors, at least one database comprising:
i) electronic user information comprising information representing at least:
a) one or more of traits and preferences of a plurality of respective persons, and
b) electronic user identification information representing contact information for at least one person of the plurality of persons; and
ii) electronic advertiser information comprising information relating to one or more of products and services associated with one or more advertising entities;
b) receiving via one or more communication devices that are operatively connected to the one or more processors, from a first computing device operated by a first user, first electronic user information comprising at least electronic identification information representing the first user;
c) receiving, via the one or more communication devices by the one or more processors from the first computing device or from a second computing device, electronic product alteration information representing at least a physical alteration of at least one of the one or more products;
d) selecting, by the one or more processors, second electronic user information comprising electronic information associated with at least some of the first electronic user information;
e) determining, by the one or more processors and based on at least one or more of the second electronic user information and the electronic product alteration information, at least one advertiser computing device associated with at least one of the one or more advertising entities to transmit the second electronic user information; and
f) transmitting, via the one or more communication devices by the one or more processors, the second electronic user information to at least one advertising computing device associated with the at least one of the one or more advertising entities.

2. The method of claim 1, wherein the electronic advertiser information further comprises information relating to one or more promotions.

3. The method of claim, 2, further comprising:
selecting, by the one or more processors and based on at least one or more of the first electronic user information and the electronic product alteration information, first electronic promotion information relating to at least one of the one or more promotions; and
transmitting, via the one or more communication devices by the one or more processors, to the first computing device, the first electronic promotion information.

4. The method of claim 3, wherein the at least one of the one or more promotions represents an offer for a free product or service.

5. The method of claim 3, wherein the at least one of the one or more promotions represents an account credit.

6. The method of claim 3, wherein the at least one of the one or more promotions relates to media featuring the first user.

7. The method of claim 3, wherein the at least one of the one or more products is provided by a first of the one or more advertiser entities and the at least one of the one or more promotions is provided by a second of the one or more advertising entities.

8. The method of claim 7, wherein the first of the one or more advertiser entities and the second of the one or more advertising entities are different advertising entities.

9. The method of claim 7, wherein the first of the one or more advertiser entities and the second of the one or more advertising entities are the same advertising entity.

10. The method of claim 1, wherein the electronic product alteration information further represents a broken seal of the at least one of the one or more products.

11. The method of claim 1, further comprising:
selecting, by the one or more processors and based on at least one or more of the first electronic user information and the electronic product alteration information, at least one social network web site; and
transmitting by the one or more processors via the one or more communication devices to at least one computing device associated with the at least one social network web site, the second electronic user information.

12. The method of claim 1, wherein the electronic product alteration information further represents at least one selected from a group consisting of:
a brand name of the at least one of the one or more products;
details of the at least one of the one or more products;
a representation that the first user altered the at least one of the one or more products;
a description of the physical alteration of the at least one of the one or more products.

13. A system, the system comprising:
(a) one or more processor readable media;
(b) one or more processors operatively coupled to the one or more processor readable media;
(c) at least one database stored on the one or more processor readable media, the at least one database comprising:
i) electronic user information comprising information representing at least:
a) one or more of traits and preferences of a plurality of respective persons, and
b) electronic user identification information representing contact information for at least one person of the plurality of persons; and
ii) electronic advertiser information comprising information relating to one or more of products and services associated with one or more advertising entities,
wherein the one or more processor readable media have instructions for causing the following steps to be performed by the one or more processors:
i) receive via one or more communication devices that are operatively connected to the one or more processors, from a first computing device operated by a first user, first electronic user information comprising at least electronic identification information representing the first user;
ii) receive, via the one or more communication devices from the first computing device or from a second computing device, electronic product alteration information representing at least a physical alteration of at least one of the one or more products;
iii) select second electronic user information comprising electronic information associated with at least some of the first electronic user information;
iv) determine, based on at least one or more of the second electronic user information and the electronic product alteration information, at least one advertiser computing device associated with at least one of the one or more advertising entities to transmit the second electronic user information; and
v) transmit, via the one or more communication devices, the second electronic user information to at least one advertising computing device associated with the at least one of the one or more advertising entities.

14. The system of claim 13, wherein the electronic advertiser information further comprises information relating to one or more promotions.

15. The system of claim, 13, wherein the one or more processor readable media further have instructions for causing the one or more processors to:
select, based on at least one or more of the first electronic user information and the electronic product alteration information, first electronic promotion information relating to at least one of the one or more promotions; and
transmit, via the one or more communication devices to the first computing device, the first electronic promotion information.

16. The system of claim 15, wherein the at least one of the one or more promotions represents an offer for a free product or service.

17. The system of claim 15, wherein the at least one of the one or more promotions represents an account credit.

18. The system of claim 15, wherein the at least one of the one or more promotions relates to media featuring the first user.

19. The system of claim 15, wherein the at least one of the one or more products is provided by a first of the one or more advertiser entities and the at least one of the one or more promotions is provided by a second of the one or more advertising entities.

20. The system of claim 19, wherein the first of the one or more advertiser entities and the second of the one or more advertising entities are different advertising entities.

21. The system of claim 19, wherein the first of the one or more advertiser entities and the second of the one or more advertising entities are the same advertising entity.

22. The system of claim 13, wherein the electronic product alteration information further represents a broken seal of the at least one of the one or more products.
